(19) United States
(12) Patent Application Publication
(10) Pub. No.: US 2026/0016856 A1
(43) Pub. Date: Jan. 15, 2026

(54) ANTENNA IN PACKAGE FOR WEARABLE SYSTEM IN FLEXIBLE COMPONENT APPLICATIONS

(71) Applicant: Meta Platforms Technologies, LLC, Menlo Park, CA (US)

(72) Inventors: Weiping DOU, Cupertino, CA (US); Benjamin COOK, Woodinville, WA (US); Jiang ZHU, Cupertino, CA (US); James Andrew HAMMER, Kirkland, WA (US); Jedd PERRY, Monroe, WA (US); Gabriel Michael Rask GASSOWAY, Issaquah, WA (US); Justin LIND, Fall City, WA (US); Qiuming LI, Palo Alto, CA (US); Geng YE, San Jose, CA (US)

(73) Assignee: Meta Platforms Technologies, LLC, Menlo Park, CA (US)

(21) Appl. No.: 19/242,931

(22) Filed: Jun. 18, 2025

Related U.S. Application Data
(60) Provisional application No. 63/670,032, filed on Jul. 11, 2024.

(51) Int. Cl. G06F 1/16; H01Q 1/27; H04B 1/3827

(52) U.S. Cl. CPC G06F 1/163; G06F 1/1698; H01Q 1/273; H04B 1/385

(57) ABSTRACT

Disclosed herein are implementations of systems and methods for providing antenna in package flexible components of wearable devices. A system can include a flexible component having a back plane layer disposed along a length of the flexible component. The system can include an antenna package having an insulating layer comprising a dielectric material disposed above the back plane layer and a circuitry layer disposed above at least a portion of the insulating layer and comprising one or more electrical components for processing antenna signals. The antenna package can include an antenna layer comprising an antenna pattern disposed above the circuitry layer and configured for wireless communication of the antenna signals using the wearable device. The back plane layer can be disposed between antenna layer and a surface of the flexible component configured to interface with a user wearing the wearable device.

### CROSS-REFERENCE TO RELATED APPLICATION

This application claims priority to U.S. Provisional Patent Application No. 63/670,032, filed Jul. 11, 2024, which is incorporated by reference in its entirety for all purposes.

### FIELD OF DISCLOSURE

The present disclosure is generally related for wireless communication antennas, including, but not limited to antenna designs for wireless communications in wearable devices.

### BACKGROUND

User equipment (UE) devices, including wearable devices (e.g., smartwatches, fitness trackers, smart glasses) and other internet-of-things (IoT) wearables, can be used for wireless communication with other network devices or services via cellular, Wi-Fi or other wireless technologies. The wireless communication can be implemented using a variety of protocols using any number of antennas. Size limitations of some of the UE devices, particularly wearable devices, can impact the design and performance of the antennas utilized for various types of wireless communication.

### SUMMARY

The present disclosure provides improved wireless antenna systems for wearable devices by directly integrating antenna-in-package (AiP) modules, including protocol-specific antennas and associated circuitry provided within flexible regions of the device, such as the wristbands of smartwatches or the temples of smart glasses. Unlike conventional approaches that confine antenna placement to the rigid main body (e.g., the capsule) of the wearable device, the technical solutions of this disclosure distribute and embed optimized antenna packages within the flexible bands, thereby leveraging previously underutilized form factors for wireless performance gains.

By the virtue of being compact, wearable devices often face space limitations for antenna placement, forcing design compromises that increase the chance of electromagnetic interferences, detuning, and attenuation arising from the proximity of the antenna to the user's skin and other electronic components. These constraints often degrade antenna performance, limit efficiency and reliability across multiple frequency bands, and restrict support for diverse wireless connectivity required in modern wearable user equipment. In addition, conventional approaches that utilize shared antenna structures for multiple protocols within the main device housing must employ additional switching, filtering, and matching components, resulting in further signal loss and complexity.

To overcome these challenges, the technical solutions described herein employ a multilayer antenna package structure (e.g., AiPs) integrated within the flexible substrate of a wearable device. In one aspect, a wrist band or strap includes a backplane layer comprising an electrical conductor disposed along its length to function as both a ground reference and an isolating plane. Above the backplane, the antenna package includes an insulating dielectric layer, followed by one or more circuitry layers incorporating passive components for signal matching, filtering, and coupling, and a patterned antenna layer optimized for targeted frequency bands and wireless protocols. This arrangement allows each protocol-specific AiP module to be both electrically and mechanically self-contained, enabling independent optimization and robust mechanical stability, regardless of the varying shapes or bends of the flexible substrate.

By structurally integrating these multiple layers within the flexible portions of the wearable device, the disclosed systems facilitate robust, high-performance wireless connectivity in body-adjacent environments without sacrificing space for other critical device components. The invention further enables distributed placement of multiple antennas for multi-protocol, diversity, or multiple-input, multiple-output (MIMO) applications, reduces the effects of body loading through precise ground-plane isolation, and allows for scalable manufacturing and straightforward assembly onto flexible printed circuit substrates. Collectively, these technical solutions support next-generation wearable devices with enhanced wireless capabilities, higher efficiency, and improved reliability in compact and ergonomically favorable form factors.

An aspect of the technical solutions is directed to a system. The system can include a flexible component coupled with a wearable device. The flexible component can include a back plane layer comprising an electrical conductor material disposed along a length of the flexible component. The system can include an antenna package. The antenna package can include an insulating layer comprising a dielectric material disposed above at least a portion of the electrical conductor material of the back plane layer. The antenna package can include a circuitry layer disposed above at least a portion of the insulating layer and comprising one or more electrical components for processing antenna signals. The antenna package can include an antenna layer comprising an antenna pattern disposed above at least a portion of the circuitry layer and configured for wireless communication of the antenna signals using the wearable device. The back plane layer can be disposed between antenna layer and a surface of the flexible component configured to interface with a user wearing the wearable device.

The flexible component can include one of a wrist band of a smart watch device or a neck band or a temple of a smart glasses device. The back plane layer can be configured to one at least one of: reflect, direct or attenuate one or more body effects of the user. The one or more electrical components can include one or more of a radio-frequency switch, a variable capacitor, a tunable inductor, an amplifier, a filter, or an amplifier. The one or more electrical components can be arranged to provide one of a radio-frequency matching, signal filtering, impedance matching or signal conditioning of the antenna signals transmitted or received via the antenna package.

The antenna package can include a pads layer disposed above at least a portion of the electrical conductor material of the back plane layer and beneath at least a portion of the insulating layer. The pads layer can include one or more electrical pads configured for at least one of testing of the antenna package, tuning of a frequency response of the antenna package or electrical coupling the antenna patterns with one or more electrical conductors disposed beneath the antenna package and leading to the wearable device. The antenna package can include a second insulating layer disposed above at least a portion of the circuitry layer and beneath at least a portion of the antenna layer. The second insulating layer can provide electrical insulation between the one or more electrical components of the circuitry layer and the antenna pattern of the antenna layer.

The antenna pattern can be configured to receive or transmit the antenna signals according to a wireless communication technology of a plurality of wireless communication technologies communicated using the wearable device. The wireless communication technology can include one of: 5G new radio (NR), Long Term Evolution (LTE), narrow band Internet of Things (NB-IoT), Bluetooth, Bluetooth Low Energy (BLE), Wi-Fi, Near Field Communication (NFC), Ultra-Wideband (UWB), Global Navigation Satellite System (GNSS) communication, Zigbee, ANT wireless technology (ANT), and Long Range (LoRa).

The system can include a second antenna package spaced apart from the antenna package. The second antenna package can include a second insulating layer comprising a second dielectric material disposed above at least a second portion of the back plane layer. The second antenna package can include a second circuitry layer disposed above at least a portion of the second insulating layer and comprising one or more components for processing second antenna signals. The second antenna package can include a second antenna layer comprising a second antenna pattern disposed above at least a portion of the second circuitry layer and configured for wireless communication of the second antenna signals using the wearable device. The second antenna package can be configured to communicate antenna signals in a second one or more frequency bands of a second wireless communication technology that is different from a first one or more frequency bands of a first wireless communication technology which the antenna package is configured to communicate.

The antenna layer can be excited by a feed structure that includes at least one of: a direct feed, an aperture feed, a capacitive coupling, or an inductive coupling. The feed structure can be implemented via the insulating layer and the circuitry layer. The antenna package can be configured to operate as a part of a plurality of antenna packages disposed on a front surface of the back plane layer that is opposite to a back surface of the back plane layer that faces the surface of the flexible component configured to interface with the user, wherein each antenna package of the plurality of antenna packages is electrically coupled with the wearable device via one or more electrical conductor lines at least partly disposed along the front surface of the back plane layer.

The surface of the flexible component that is configured to interface with the user can be formed using a material disposed between the back plane layer and the surface. The material can enclose the antenna package within the flexible component to protect the antenna package from an external element. The dielectric material of the insulating layer of the antenna package can define a body of the antenna package. The body can be formed to comprise a body portion onto which the antenna layer is disposed and to provide an air gap between the body portion and the back plane layer. A size of the air gap of the antenna package, which is configured for a first wireless communication technology, can be different than a second size of a second air gap between a second body portion of a second antenna package and the back plane layer. The second size of the second air gap can be selected according to a second wireless communication technology of the second antenna package which can be different than a first wireless communication technology of the antenna package for which the size of the air gap of the antenna package is selected.

The dielectric material of the insulating layer can include a dielectric constant that is less than 4. The electrical conductor material of the back plane layer can comprise a metal. The system can include a distance gap provided between the insulating layer and the back plane layer. The distance gap can be selected based on a type of wireless communication for which the antenna package is configured. The distance gap can be configured to decrease at least one of detuning, attenuation, or signal loss arising from proximity to the user.

The antenna package can include one or more electrical contacts on a bottom side of the antenna package interfacing with the back plane layer. The one or more electrical contacts can be configured to electrically connect the antenna package to a corresponding one or more contacts on the back plane layer, such that the antenna package can be removed from the flexible component and replaced with another antenna package while the back plane layer remains with the flexible component.

An aspect of the technical solutions is directed to a method. The method can include providing a flexible component coupled with a wearable device. The method can include disposing an electrical conductor material of a back plane layer of a flexible component along a length of the flexible component. The flexible component can be coupled with a wearable device. The method can include mounting, onto the back plane layer, an antenna package, the antenna package. The antenna package can include an insulating layer comprising a dielectric material disposed above at least a portion of the electrical conductor material of the back plane layer. The antenna package can include a circuitry layer disposed above at least a portion of the insulating layer and comprising one or more electrical components for processing antenna signals. The antenna package can include an antenna layer comprising an antenna pattern disposed above at least a portion of the circuitry layer and configured for wireless communication of the antenna signals using the wearable device. The back plane layer can be disposed between antenna layer and a surface of the flexible component configured to interface with a user wearing the wearable device.

The method can include the flexible component that can include one of a wrist band of a smart watch device or a neck band or a temple of a smart glasses device and the back plane layer can be configured to one at least one of: reflect, direct or attenuate one or more body effects of the user. The method can include providing the one or more electrical components that comprise one or more of a radio-frequency switch, a variable capacitor, a tunable inductor, an amplifier, a filter, or an amplifier. The method can include arranging one or more electrical components to provide one of a radio-frequency matching, signal filtering, impedance matching or signal conditioning of the antenna signals transmitted or received via the antenna package.

The method can include mounting, onto back plane layer, a second antenna package spaced apparat from the antenna package. The second antenna package can include a second insulating layer comprising a second dielectric material disposed above at least a second portion of the electrical conductor material of the back plane layer. The second antenna package can include a second circuitry layer disposed above at least a portion of the second insulating layer and comprising one or more components for processing second antenna signals. The second antenna package can include a second antenna layer comprising a second antenna pattern disposed above at least a portion of the second circuitry layer and configured for wireless communication of the second antenna signals using the wearable device. The second antenna package can be configured to communicate antenna signals in a second one or more frequency bands of a second wireless communication technology that is different from a first one or more frequency bands of a first wireless communication technology which the antenna package is configured to communicate.

An aspect of the technical solutions is directed to an antenna package in a flexible component coupled with a wearable device. The antenna package can be mounted on a back plane layer of a flexible component coupled with a wearable device. The back plane layer can include an electrical conductor material disposed along a length of the flexible component. The antenna package can include an insulating layer comprising a dielectric material disposed above at least a portion of the electrical conductor material of the back plane layer. The antenna package can include a circuitry layer disposed above at least a portion of the insulating layer and comprising one or more electrical components for processing antenna signals. The antenna package can include an antenna layer comprising an antenna pattern disposed above at least a portion of the circuitry layer and configured for wireless communication of the antenna signals using the wearable device. The back plane layer can be disposed between antenna layer and a surface of the flexible component configured to interface with a user wearing the wearable device.

### BRIEF DESCRIPTION OF THE DRAWINGS

The accompanying drawings are not intended to be drawn to scale. Like reference numbers and designations in the various drawings indicate like elements. For purposes of clarity, not every component can be labeled in every drawing.

FIG. 1A is a plan view of an example wristband system that may include the flexible component according to at least one implementation of the technical solutions.

FIG. 1B is a side view of the example wristband system of FIG. 1A, according to at least one implementation of the technical solutions.

FIG. 2 is an illustration of a system example with an antenna package deployed on a back plane, according to at least one implementation of the technical solutions.

FIG. 3 illustrates an example circuitry for implementing a radio frequency (RF) front end processing in an antenna package.

FIGS. 4A-B illustrate perspective views of an example antenna package implemented on an antenna package body, according to an implementation.

FIGS. 5A-C illustrate perspective views of an example antenna package body with an internal hollow cavity providing an air gap, according to an implementation.

FIGS. 6A-B illustrate perspective views of a plurality of antenna packages disposed within a flexible component, according to an embodiment.

FIGS. 7A-B illustrate a set of perspective views of a plurality of antenna packages disposed within a flexible component, according to another embodiment.

FIG. 8 illustrates an example configuration of a flexible component having an antenna package and a back plane layer aligned with a back surface interfacing with the user's body, according to an embodiment.

FIG. 9 is a block diagram of a computing environment that can be utilized in a wireless wearable device, according to an example implementation of the present disclosure.

FIG. 10 is a flow diagram of a method for providing an antenna package on a back plane, according to at least one implementation of the technical solutions.

### DETAILED DESCRIPTION

Before turning to the figures, which illustrate certain embodiments in detail, it should be understood that the present disclosure is not limited to the details or methodology set forth in the description or illustrated in the figures. It should also be understood that the terminology used herein is for the purpose of description only and should not be regarded as limiting.

The present disclosure relates to antenna packages implemented within flexible components of the wearable device accessories, such as wrist bands or neck bands of a wearable device. Wearable electronic devices, such as smartwatches, fitness trackers (e.g., smart bands), smart rings, smart glasses, wireless earbuds, or other types of user equipment, can utilize various wireless technologies, such as Bluetooth, Wi-Fi, New Radio (NR), Long Term Evolution (LTE), Global Navigation Satellite System (GNSS), Near Field Communication (NFC), Ultra-Wideband (UWB), and others. The compact form factor of these wearable electronic devices can result in limited and insufficient internal volume, constraining the design of high performance antennas. For example, dense arrangements of electronics inside a wearable device can lead to scarcity of space for antennas, resulting in the antenna designs compromising with reduced efficiency, restricted bandwidth, and difficulty in fully supporting multiple wireless technologies or standards. Further, the close proximity to the human body to the wearable device can introduce body effects such as detuning, attenuation, and signal shadowing, since the user's skin, with its high permittivity and some electrical conductivity, can adversely affect the antenna performance.

When antennas are placed in movable wearable device components, such as the wrist bands of wearable devices, antenna performance can be impacted by detuning as the flexible band can be subject to mechanical strains (e.g., bending of the wrist band), leading to mechanical instability and reduced robustness. Using antenna signal processing circuitry to provide signal matching, filtering or conditioning within the wrist band and encapsulating these components with liquid silicone or other materials may be insufficient to provide sufficient mechanical and electrical protection due to external interferences. Efforts to tune antenna performance can include making iterative adjustments to sub-assemblies, complicating the manufacturing process. By integrating electrical circuit components of the RF front end directly within the dedicated antenna modules, RF loss can be reduced, preventing unwanted noise propagation, and preserving valuable space within the wrist band.

To address these issues, the technical solution can incorporate into a flexible component (e.g., a wrist band, a neck band or a temple of smart glasses) one or more compact, integrated antenna packages (e.g., AiPs), each of which can be configured or optimized for particular wireless technologies. The flexible component can include a back plane layer composed of conductive material running along the length of the wrist band and serving as a ground plane or reflector to manage negative effects associated with human body proximity (e.g., attenuate the body effects). The back plane can support thereon one or more antenna packages, each of which can include its own one or more antenna layers configured for antenna signals of a particular wireless technology, circuitry layers for front end RF processing the antenna signals of the antenna layers and insulating layers for insulating the circuitry layers from the back plane. The resulting system can include an array of antenna packages, each one configured for a different wireless technology, providing the wearable device utilizing these antenna packages with improved antenna performance across various wireless technologies.

Each antenna package (e.g., AiP) can be mounted over an electrical conductor material of the back plane layer within the flexible component. An insulating layer of such an antenna package can include a dielectric material disposed above the electrical conductor material of the back plane layer. The insulating layer can provide electromagnetic isolation and antenna spacing from the back plane and the user's body. Above the insulating layer, within the antenna package, a circuitry layer can include RF components (e.g., circuits) arranged or configured to provide one or more matching networks, signal filters, or switches, to process or adjust (e.g., optimize) the antenna signals for particular wireless channels and wireless communication bands of the wireless technology for which the antenna package is configured. An antenna layer of the antenna package can be disposed above the insulating layer and can include an antenna pattern arranged, shaped and sized for the given wireless technology in order to satisfy the given communication protocols. The back plane layer, which can be positioned between the antenna package and the user's skin, can reduce absorption and detuning effects caused by contact with the body and can support any number of antenna packages within the flexible component.

The antenna packages can be designed to support modularity and independent tunability. The antenna packages can include dedicated test and tuning pads that enable stand-alone verification, testing, and fine-tuning of antenna performance without triggering modifications to the broader flexible component (e.g., the wrist band) or to the backplane. By configuring each antenna package to support a single wireless technology (e.g., a single wireless protocol), multiple antenna packages included within the flexible component can each be optimized for maximized performance across specific wireless technologies, such as Bluetooth, NR, LTE, Wi-Fi, or GNSS.

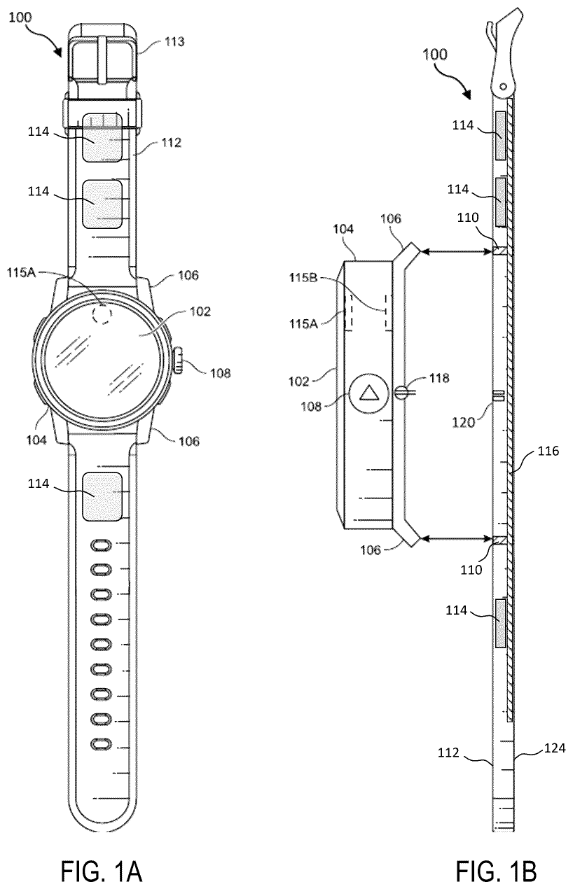

Referring now to FIGS. 1A and 1B, an example of a wearable communication device, implemented as a wireless wristband system 100, is illustrated. The wristband system 100 can include, or be coupled with, a flexible component that can include a plurality of antenna packages. For example, a wristband system 100 of FIGS. 1A and 1B, can be a smartwatch device, which can include, be used in isolation or in conjunction with, other systems, including artificial-reality (AR) systems, such as any virtual-reality or augmented reality systems. The wristband system 100 can include a flexible component 112, which in an example system can be implemented as a wrist band, also referred to as a watch band. The flexible component 112 (e.g., the wrist band) can be configured to interface with a user's wrist and that can be electrically coupled with the electronics (e.g., processors, memory and antenna signal processing circuitry of a smart watch) within the watch body 104. Further, the flexible component 112 (e.g., the watch band) may include, seal, at least partially enclose or comprise within, one or more antenna packages 114 that may include antennas that are optimized for specific wireless technologies (e.g., specific wireless communication protocols) along with any filtering and signal processing circuitries for such wireless communications. The antenna packages 114 can be disposed on one or more back plane layers 116 that may be disposed along the length of the flexible component and can be arranged to be parallel to the back surface 124 of the flexible component 112 that is configured to interface with the skin (e.g., the wrist) of the user.

FIGS. 1A and 1B illustrate an embodiment of the example wristband system 100 that can include a watch band (e.g., as the flexible component) that is configured to couple with a watch body (e.g., the electronic device portion of the smart watch). As shown in FIG. 1A, the wristband system 100 can have a watch body 104 and the flexible component 112 (e.g., the watch band) that may have any size or shape that is configured to allow a user to wear the wristband system 100 on a body part (e.g., around a user's wrist). The wristband system 100 may include a retaining mechanism 113 (e.g., a buckle) for securing watch band 112 to the user's wrist. The wristband system 100 may also include a coupling mechanism 106, 110 for detachably coupling watch body 104 to watch band 112. Still further, the wristband system 100 may include a button or wheel 108 that allows users to interact with the wristband system 100 including applications that run on the system.

Wristband system 100 may perform various functions associated with the user. The functions may be executed independently in watch body 104, independently in watch band 112, and/or in communication between watch body 104 and watch band 112. Watch band 112 and its associated antennas may be configured to operate independently (e.g., execute functions independently) from watch body 104. Additionally or alternatively, watch body 104 and its associated antennas may be configured to operate independently (e.g., execute functions independently) from flexible component or watch band 112. At least in some cases, watch band 112 and/or watch body 104 may each include the independent resources required to independently execute functions. For example, flexible component (e.g., the watch band) and/or watch body 104 may each include a power source (e.g., a battery), a memory, data storage, a processor (e.g., a CPU), communications (including multiple different types of antennas). The flexible component and the watch body can include a light source (e.g., at least one infrared LED for tracking watch body 104 and/or watch band 112 in space with an external sensor), and/or input/output devices.

FIG. 1B illustrates an example wristband system 100 that includes a watch body 104 decoupled from a flexible component 112 (e.g., the watch band). The flexible component or the watch band 112 may flexible and configured to be donned (e.g., worn) on a body part (e.g., a wrist) of a user and may operate independently from watch body 104. For example, watch band 112 may be configured to be worn by a user and an inner or back surface of flexible component (e.g., surface 124) may be configured to be contact with the user's skin. Parallel to the back surface 124, the flexible component 112 can include a back plane layer 116 comprising an electrical conductor material (e.g., a metal layer) can be disposed along the length of the flexible component to provide a block or a separation to the antenna packages 114 from the body effects of the user's body.

When a flexible component 112 is worn by a user, the back plane layer 116 may be positioned or disposed between the user's skin and the antenna packages 114, thereby reducing, attenuating or blocking the body effects from affecting the antenna packages 114. The flexible component (e.g., the watch band) 112 may include multiple antenna packages 114 disposed on a top surface of the back plane layer 116, allowing the bottom surface of the back plane layer 116 to face or interface with the back surface 124 of the flexible component that is in contact with the user's skin. The antenna packages 114 can be disposed within the material of the watch band, such as within the interior volume of the flexible component 112.

In some examples, watch body 104 may include an electrical connector 118 that mates with connector 120 of watch band 112 for wired communication and/or power transfer. The connector 120 can be electrically coupled with the antenna packages 114 to allow for antenna signals to be communicated between the antenna packages 114 and the processors, circuitry or electronics within the watch body 104. In some examples, the watch body 104 can be electrically coupled with the antenna packages 114 via electrical conductor lines disposed or run along or within the flexible component 112 (e.g., the watch band) to communicate (e.g., transmit and receive) antenna signals for various types of wireless communication. The individual antenna packages 114 can be configured (e.g., have antenna geometries, sizes, shapes and offsets sized to maximize the performance) for a given type of wireless communication, such as LTE, GPS, Bluetooth, Wi-Fi, NFC, or other types of wireless communication.

The example wristband system 100 can include a coupling mechanism for detachably coupling watch body 104 to the flexible component 112, which can also electrically couple or decouple the electrical connector 118 of the watch body with the connector 120 of the flexible component 112 (e.g., the watch band). For instance, a user may detach a watch body 104 from watch band 112 in order to reduce the encumbrance of wristband system 100 to the user. Detaching watch body 104 from watch band 112 may reduce a physical profile and/or a weight of wristband system 100. Wristband system 100 may include a watch body coupling mechanism(s) 106 and/or a watch band coupling mechanism(s) 110. A user may perform any type of motion to couple watch body 104 to watch band 112 and to decouple watch body 104 from watch band 112. For example, a user may twist, slide, turn, push, pull, or rotate watch body 104 relative to watch band 112, or a combination thereof, to attach watch body 104 to watch band 112 and to detach watch body 104 from watch band 112.

As illustrated in FIG. 1B, in some examples, watch body 104 may include front facing image sensor 115A and rear-facing image sensor 115B. For example, the watch band may include one or more sensors inserted in the flexible component 112 and facing or passing through the surface 124 to couple the signals with the user's body. Sensors, such as the front-facing image sensor 115A, may be located in a front face of watch body 104 (e.g., substantially near, under, or on the display 102), and rear-facing image sensor 115B may be located in a rear face of watch body 104. In some examples, a level of functionality of at least one of watch band 112 or watch body 104 may be modified when watch body 104 is detached from watch band 112. The level of functionality that may be modified may include the functionality of front-facing image sensor 115A and/or rear-facing image sensor 115B. Alternatively, the level of functionality may be modified to change how the various antennas within the system. For instance, as will be described further below, the embodiments herein may include a cosmetic RF transparent feature that may form a functional link between wrist strap antennas and internal electronic components including tuners, amplifiers, controllers, and data processors.

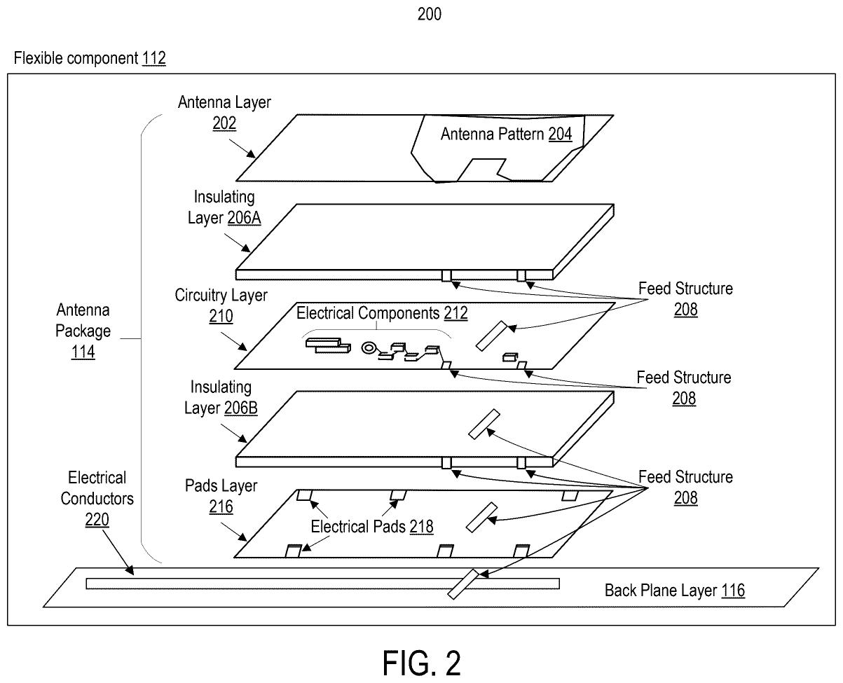

FIG. 2 is an illustration of a system example 200 with an antenna package and its internal components deployed on a back plane layer 116 within a flexible component 112, according to at least one implementation of the technical solutions. The example system 200 can correspond to an arrangement or a configuration in which an antenna package 114 is disposed, deployed or otherwise supported on a back plane layer 116 within a flexible component 112. As shown in FIG. 2, the antenna package 114 can include, or be formed using, one or more structural or functional layers, including an antenna layer 202, a first insulating layer 206A, a circuitry layer 210, a second insulating layer 206B and a pads layer 216. The back plane layer 116 and the one or more antenna packages 114 can be included or sealed within the material of the flexible component 112 allowing for a dual functionality as both a wearable feature (e.g., wrist band, neck band, or a temple of glasses) and the antenna components of a wireless device.

As illustrated in FIG. 2, a system 200 can include a flexible component 112 that can be mechanically and electrically coupled with a wearable wireless communication device (e.g., a watch body 104). The flexible component 112 can include a back plane layer 116 that can include any flexible electrical conductor material, which can be disposed within or run along the flexible component 112. The flexible component 112 can include one or more antenna packages 114 that can be disposed, support or provided on a surface of the back plane layer 116 that is opposite of the surface of the back plane layer 116 facing the surface 124 of the flexible component 112 facing or interfacing with the user.

The antenna package 114, also referred to as antenna-in-package or AiP, can include a pads layer 216 that can be disposed on top of at least a portion of the back plane layer 116 and include one or more electrical pads 218 that can electrically couple with one or more electrical contacts of electrical conductors 220 on the back plane layer 116. On top of the pads layer 216, the antenna package 114 can include an insulating layer 206B which can include a layer of a dielectric material, a layer of printed circuit board (PCB) material, such as a polyimide, a layer of an electrically insulating epoxy material, or an air gap 404 formed by a body of the antenna package 114. The insulating layer 206B can be configured to electrically insulate electrical pads 218 of the pads layer 216 from other electrical contacts (e.g., electrical components 212 at the circuitry layer 210), as well as reduce or eliminate electromagnetic interferences between electrical contacts or components at the pads layer 216 or the back plane layer 116 below the insulating layer 206B and the electrical contacts and components at the circuitry layer 210 and the antenna layer 202 above the insulating layer 206B.

The antenna package 114 can include a circuitry layer 210 that can include electrical components 212 arranged to create RF front end circuitry, such as antenna signal filtering, amplification and impedance matching. On top of the circuit layer 210, the antenna package 114 can include an insulating layer 206A with a dielectric material providing electrical and electromagnetic interference insulation and separation between the circuitry layer 210 and the antenna layer 202. On top of the antenna package 114, the antenna layer 202 can provide an antenna pattern 204 arranged, formed or configured for wireless transmission and receiving of signals in all of the wireless bands of any particular wireless technology (e.g., Bluetooth, Wi-Fi, LTE, NR or any other). The feed structure 208, including one or more electrically conductive contacts or components routed through the pads layer 216, the insulating layer 206B, the circuitry layer 210 and the insulating layer 206A can provide electrical connectivity (e.g., feed structure 208) between the electrical conductors 220 of the back plane layer 116 and the antenna pattern 204 at the antenna layer 202. While FIG. 2 illustrates an example of flat and planar layers stacked to form an antenna package 114, it is understood that layers may not be planar or flat, but rather functional and deposited, formed or provided on any shape or surface that may be used to create or produce an antenna package 114.

The flexible component 112 can be any type and form of band, strap, loop, component or armature that is configured to interface with the user's body and support, house or enclose within one or more antenna packages 114. The flexible component 112 can include a flexible material to be worn by the user that seals or protects electronic assemblies (e.g., back plane layers 116 and antenna packages 114), while also providing flexibility, comfort, and ergonomic compatibility for wearable applications. The flexible component 112 can comprise any one of: a wrist band of a smart watch device, a neck band of a smart glasses device, or a temple of a smart glasses device, and is not limited to these examples, as other wearable or body-adjacent implementations are contemplated.

The flexible component 112 can include polymeric materials such as silicone, polyurethane, thermoplastic elastomers, polyimide, or natural or synthetic fabrics. The flexible component 112 can incorporate reinforcements, conductive traces, coatings, or encapsulants to enhance durability, moisture resistance, or electromagnetic shielding. The flexible component 112 can include cavities, channels, or recesses designed to accommodate the back plane layer 116, the antenna package 114, associated wiring, or additional sensor modules or subsystems. The flexible component can include an inner or a back surface that is configured to interface with a user wearing the wearable device, such as the wrist, neck, or head, and may be formed with user-facing materials selected for comfort, biocompatibility, or sweat resistance. In certain embodiments, the flexible component 112 can include a protective cover layer or encapsulation that substantially or entirely encloses the antenna package 114 and the back plane layer 116 to shield them from mechanical damage, environmental exposure, or ingress of liquids and debris. In addition, the flexible component 112 can be configured with attachment points, connectors, or modular interfaces for coupling with the main body of the wearable device (such as a watch housing or smart glasses frame), as well as features to support charging, inter-module communication, or user customization.

The flexible component 112 can include one or more back plane layers 116. A back plane layer 116 can include any type and form of electrically conductive structure, such as a continuous or patterned metallic sheet, a woven or laminated flexible metal or other conductor, or a multilayer stack integrating conductor traces or meshes. The back plane 116 can include one or more PCBs comprising one or more electrical conductors. The back plane PCBs can comprise flexible electrically insulating materials comprising one or more electrical conductors 220 (e.g., copper or aluminum electrical lines) connecting any of the electrical pads 218 or the feed structure 208 with the wireless compute device (e.g., smart watch or the smart glasses unit). The back plane layer 116 can include an electrical conductor material, such as a sheet of metal or any other flexible and electrically conductive material, such as copper, aluminum, silver, conductive polymers, or composite conductors reinforced with metal or carbon fibers. The back plane layer 116 can be implemented as a single conductive sheet or as a plurality of segments or traces arranged to suit the geometry and functional requirements of the flexible component 112. In some implementations, the back plane layer 116 may incorporate selectively thinned or thickened regions, perforations, or patterned cut-outs to balance electrical, mechanical, and ergonomic objectives within the wearable device.

The back plane layer 116 can be disposed between the antenna layer and a surface of the flexible component configured to interface with a user wearing the wearable device in order to reflect, direct, or attenuate one or more body effects of the user, such as electromagnetic detuning, signal attenuation, or shadowing due to proximity to the user's skin. The back plane layer 116 can include a front or an outer (e.g., top) surface on which the antenna packages 114 are disposed and a back, or an inner (e.g., bottom) surface that runs adjacent to the surface of the flexible component interfacing with the user's body. In some embodiments, the thickness and material selection of the back plane layer 116 are chosen to maximize signal performance, isolation, and efficiency for specific frequency bands or wireless protocols, and the back plane may be engineered to support dedicated ground planes, reflectors, or director elements for the antenna packages.

The back plane layer 116 can be surrounded or sealed by a material forming at least a portion of the flexible component 112 for environmental and mechanical protection. In some implementations, the back surface of the back plane layer 116 is the surface of the flexible component 112 interfacing with the user, while in other implementations, the back plane may be encapsulated within or covered by a soft or protective material layer of the flexible component (e.g., silicone rubber, thermoplastic polyurethane, polyimide, nylon fabric or any elastomeric material). The back plane layer 116 can include electrical contacts (e.g., feed or ground contacts) for electrically coupling with the electrical pads 218 of the antenna packages 114. The back plane layer 116 can include one or more electrical conductors 220 or traces adapted for routing antenna signals or control lines between the antenna layers 202 of the antenna packages 114 and the core processing or transceiver elements of the wearable device (e.g., the device body 104). These electrical conductors 220 may be formed integrally with, or separately from, the main back plane layer 116 electrical conductor sheet, such as electrically conductive lines formed or etched within the back plane layer 116. These electrical conductors 220 can provide connections, testing points, or tuning interfaces for the antenna packages 114.

The antenna package 114 can be any type and form of modular or integrated assembly designed for transmitting or receiving wireless signals for a wearable wireless communication device. The antenna package 114 can include one or more layers (e.g., 216, 206B, 210, 206A, and 202) which can be arranged to provide effective signal transmission and reception while being sufficiently compact and mechanically robust for use in flexible, user body-adjacent environments. The layers of the antenna package 114 can include any arrangement or combination of one or more antenna layers 202 providing an antenna pattern 204 configured for a particular type of wireless technology (e.g., Bluetooth, Wi-Fi, LTE, NR or other), insulating layers 206 for providing electrical and electromagnetic interference insulation, circuitry layers 210 with electrical components 212 providing RF front end functionality and pads layers 216 for providing electrical pads or contacts for coupling with the electrical conductors 220 along the back plane layer 116. These layers can be assembled, laminated, or otherwise joined as a unit or a single structure on a body or a substrate forming the antenna package 114. The antenna package 114 can be configured for installation on or above a back plane layer 116 within the flexible component 112, and can be disposed at any suitable location along the flexible component as dictated by desired wireless functionality (for example, for multi-band, diversity, or spatially distributed applications). The antenna package 114 can be configured for permanent, semi-permanent, or removable installation, and can be sized and shaped to match the geometry of the wearable device.

The antenna package 114 can include an antenna layer 202 comprising an antenna pattern 204 that may be implemented as a printed, plated, etched, or otherwise deposited pattern of electrically conductive material, suitable for operation across one or more wireless technologies or communication protocols. For instance, the antenna pattern 204 can be formed, sized or arranged to conform to any wireless bands or channels of any one or more of: 5G NR, LTE, NB-IoT, Bluetooth, BLE, Wi-Fi, NFC, UWB, GNSS, Zigbee, ANT, or LoRa. The antenna pattern 204 may be designed as a single-band, multi-band, or broadband structure, and can be operated or excited via a feed structure 208.

The antenna pattern 204 can include any arrangement of metal lines or features, including copper, silver, aluminum or any other conductive material. The antenna pattern 204 can have the geometry or layout of the metal lines whose sizing and shapes can be arranged or selected to optimize parameters such as gain, efficiency, polarization, and radiation pattern in accordance with the specific wireless standard. This means that the antenna pattern 204 optimized or designed for a first wireless technology (e.g., Bluetooth) at a first antenna package 114 can be differently sized, arranged or shaped than a second antenna pattern 204 optimized or designed for a second wireless technology (e.g., LTE), which can still be different from a third antenna pattern 204 of a third antenna package 114 for a third wireless technology (e.g., Wi-Fi). These antenna patterns 204 can include features such as slots, patches, loops, or dipole segments, and may be configured for use in arrays or in conjunction with additional antenna packages 114 to provide diversity or MIMO functionality. The antenna patterns 204 can be electrically isolated from other components by intervening dielectric layers 206 and protected by encapsulation or coating materials to shield them from environmental exposure or mechanical stress.

The feed structure 208 providing electrical coupling to the antenna pattern 204 can span multiple layers (e.g., 216, 206B, 210, 206A and 202) across the antenna package stack. The feed structure 208 can comprise any one or more of a direct feed, aperture coupling, capacitive coupling, or inductive coupling, routed from the underlying layers. The feed structure 208 can include a direct feed structure that can be realized via vertically aligned conductive vias, while aperture feeds may employ slots or windows for electromagnetic coupling from electrical conductors 220 (e.g., the microstrip lines) situated in back plane layer 116 or underlying layers. The antenna package 114 can include one or more insulating layers, such as a first insulating layer 206A disposed between the antenna layer 202 and the circuitry layer 210, and a second insulating layer 206B disposed between the circuitry layer 210 and the pads layer 216. These insulating layers can be formed from low-loss dielectric materials (for instance, polyimide, PTFE, or other polymers) which can have dielectric constants less than 4, and can be configured to provide appropriate air gaps and electromagnetic isolation between the respective layers.

The circuitry layer 210 of the antenna package 114 can include one or more electrical components 212 for processing antenna signals transmitted or received via the antenna layer 202. The electrical components 212 of the circuitry layer 210 can include radio-frequency switches, variable capacitors, tunable inductors, amplifiers, filters, resistors and other components. These electrical components 212 can be arranged to provide impedance matching, signal filtering, gain, or tuning for antenna signals transmitted or received via the antenna pattern 204. For instance, circuitry layer 210 can receive from the wireless wearable device an antenna signal to be transmitted via the antenna pattern 204. The circuitry layer 210 can amplify the antenna wireless signal at a particular signal strength level selected for the particular wireless band of the given wireless technology in order to maintain a predetermined signal strength level threshold for the antenna signal at that wireless band, prior to sending the amplified signal to the antenna pattern 204 for transmission. For example, the antenna signal received via the antenna pattern 204 at a particular wireless frequency band of the dedicated wireless technology can be filtered by the circuitry layer 210 at a particular frequency range prior to forwarding the filtered signal, via the feed structure 208 and the electrical conductors 220 to the wireless wearable device. In doing so, the circuitry layer 210 can provide all the RF front end signal processing, such as tuning, switching among different frequency bands, dynamic impedance matching, automatic gain control, and adaptive filtering to optimize signal integrity and reduce interference.

The circuitry layer 210 can further include integrated control logic, sensor interfaces, or feedback circuitry to facilitate real-time adjustment of matching or filtering components in response to changes in operating environment or antenna loading conditions. The circuitry layer 210 can be reconfigurable or software programmable, allowing the antenna package 114 to support multiple wireless protocols or dynamically switch between such protocols in response to software instructions or switch signals from the wearable device. The electrical components 212 of the circuitry layer 210 can be arranged in fixed or tunable networks, and can be selectively accessed or controlled via external signals or through diagnostic and tuning pads for maintenance or calibration. For example, the circuitry layer 210 can include one or more electrical components 212 configured to provide at least one of impedance matching, signal tuning, signal switching, filtering, amplification, or signal conditioning functions for antenna signals at one or more wireless frequency bands supported by the antenna layer 202.

The circuitry layer 210 can be implemented with discrete surface-mount components, integrated passive devices, thin-film structures, or any suitable configuration. Beneath the circuitry layer 210, a pads layer 216 can be included, comprising a plurality of electrical pads 218 configured to interface electrically and mechanically with corresponding electrical contacts or conductors on the back plane layer 116. These electrical pads 218 can include testing pads, tuning pads, and signal feed or ground pads, enabling modular or field-replaceable installation, as well as post-manufacturing adjustment or inspection. In some implementations, the pads layer 216 can operate as a mechanical interface layer, facilitating the secure attachment of the antenna package 114 to the back plane layer 116 with high positional accuracy. The structure and assembly of the antenna package 114 can be further configured so that the package can be removed from the flexible component and replaced with a different or upgraded antenna package, without requiring removal or replacement of the back plane layer 116. Optionally, the antenna package 114 can be enclosed, encapsulated, or otherwise sealed within a material forming part of the flexible component 112 for protection against external environmental elements and mechanical stress, while the design of the package ensures maintenance of the critical distance gaps and overall signal integrity between the antenna and user-facing surfaces, thereby reducing body effects such as detuning or attenuation.

The insulating layers 206A and 206B of the antenna package 114 can be or include any functional dielectric layers configured to provide electrical insulation or mechanical separation between adjacent electrically conductive components or layers. For instance, the insulating layers 206A or 206B can each include a layer of dielectric material, an electrically insulating epoxy, a PCB material, a polyimide or an air gap 404 formed by a material forming the antenna package 114. The insulating layers 206A and 206B can be disposed between any two or more layers, such as between the antenna pattern 204 of the antenna layer 202 and the circuitry layer 210, between the circuitry layer 210 and the pads layer 216, or between the pads layer 216 and the back plane layer 116. These insulating layers can include materials with a low dielectric constant, such as polyimide, PTFE, silicone, epoxy resins, polyester, polyurethane, or composite polymers, which may be used to reduce or minimize radio-frequency interference and loss, improving antenna efficiency.

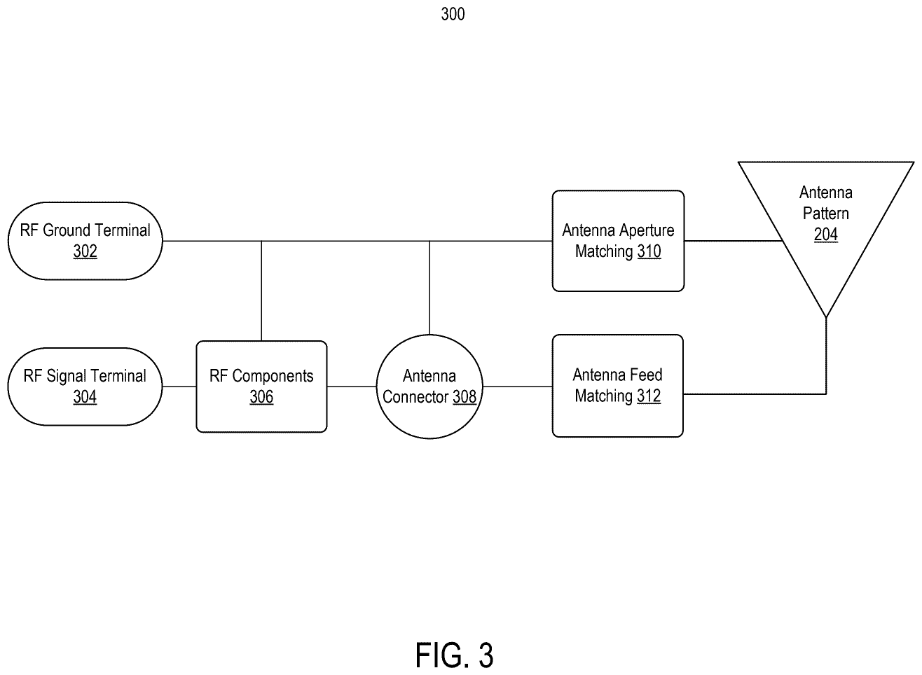

The insulating layers 206A and 206B can be implemented using single or multilayer films, molded substrates, coatings, foams, or hollow or semi-hollow structures designed to create controlled air gaps, support structural rigidity, or enable controlled electromagnetic field distribution. In some implementations, the antenna package 114 can include a backplane layer 116 with an air gap 404 or a layer of epoxy resin operating as the insulating layer 206B. The electrical pads 218 can be mounted on a bottom surface of the circuitry layer 210 and be electrically connected to the electrical conductors 220 of the back plane layer 116. The circuitry layer 210 can have the electrical components 212 operating as RF components 306 and antenna connectors 308 of FIG. 3 to operate the antenna pattern 204 at the antenna layer 202. The thickness, dielectric properties, and geometry of the insulating layers 206 can be selected according to the requirements of specific wireless technologies or the desired degree of isolation between functional layers. In some embodiments, the insulating layers 206A and 206B may not be limited to planar or flat configurations, but may be functionally deployed over surfaces or objects with arbitrary shape or curvature, variable cross-sections, or complex three-dimensional geometric forms to conform to the overall design of the flexible component 112 and the wearable device. These layers can also include features such as vias, apertures, slots, or embedded mechanical supports to facilitate passage of feed structure 208 and its feed lines, mounting features, or integration of test pads and tuning elements within the antenna package 114 assembly.

At the base of the antenna package 114 a pads layer 216 can be supported on and interface with the back plane layer 116. The pads layer 216 can include electrical pads 218 providing electrical interface with the electrical conductors 220 on the back plane layer 116. The pads layer 216 can include any structural or functional material layer (e.g., a substrate or an insulator) that is configured to provide a mechanical support and an electrical interface between the back plane layer 116 and the antenna package 114. The pads layer 216 can provide spacing for electromagnetic or environmental shielding between the back plane layer 116 or the body effects of the user and the antenna package 114. The pads layer 216 can include any type and form of material used for interfacing between electrical conductor layers, such as those in the back plane layer 116 and the electrical components 212 or antenna patterns 204. For example, the pads layer 216 can include a printed circuit board, a flexible polyimide material, ah epoxy, or other dielectric materials, as well as embedded structures (e.g., electrical pads) suited for electrical connections and repeated assembly or replacement.

The electrical pads 218 can be any electrically conductive components, such as metal sites or pads, protrusions, or terminals. The electrical pads 218 can include any electrically conductive features, such as solder pads, ball grid array contacts, spring-loaded pins, contact fingers, or conductive adhesives. The electrical pads can include, for example, contacts for direct feed, test, tuning, signal ground, or other signal conditioning or diagnostic purposes required for operation, tuning, or replacement of the antenna package 114. The feed structure 208 can include any type and form of coupling structure or electrical feed, including direct electrical feed, aperture slot feed, inductive coupling, capacitive coupling, or other feed mechanisms that can be used to facilitate transfer of antenna signals from electrical conductors 220 on the back plane 116 toward the antenna pattern 204 (e.g., via various electrically conductive components of the feed structure 208). Each antenna package 114 can be electrically coupled to the wearable device via one or more dedicated electrical conductor lines routed along the back plane layer 116 for independent signal routing, and the pads layer 216 can further comprise specific testing and tuning pads to facilitate factory calibration, in-field diagnostics, or post-deployment adjustment of the antenna package.

The antenna package 114 may be configured as a modular, field-replaceable unit that can be selectively removed from the flexible component 112 and replaced with a different or upgraded antenna package without disturbing or removing the back plane layer 116 or the remainder of the wearable device. This modular design of the antenna package 114 can be achieved, for example, by arranging electrical pads 218 at the base of the antenna package 114, such that these electrical pads 218 that are aligned with their corresponding contacts on the top surface of the back plane layer 116. The antenna package 114 can be detachably coupled from the back plane layer 116 via solder connection, pressure contacts, or mechanically fastened interfaces such as snap-in, clamp, or spring-loaded connectors. This can allow quick assembly and disassembly and allows end users, service personnel, or automated equipment to upgrade, tune, or service the antenna package 114 independently from the supporting back plane and flexible component. The antenna package 114 can include alignment features, locating pins, or registration marks to ensure precise and repeatable placement in relation to the back plane layer 116, supporting both mechanical and electrical performance.

The antenna package 114 can be configured to include a dielectric air gap or specified spacing between various layers, such as between the antenna pattern 204 and the back plane layer 116, or between the insulating layer 206 and the electrical pads 218 or the back plane layer 116. The dimensions of such an air gap can be selected or tuned based on the wireless technology, frequency band, or wireless technology or protocol to be supported by the antenna package 114. The air gap size can be selected based on the threshold level of signal or interference attenuation, impedance and resonance levels for a distinct communication protocol. For instance, a larger air gap may be provided for LTE or UWB antenna packages 114, while a smaller gap may suffice for Bluetooth or NFC antenna packages 114. The air gaps sizes may therefore have threshold distances of separation to achieve between the antenna pattern 204 and the back plane or circuitry layer 210. The air gaps can be established through the use of molded spacers, foam supports, precisely layered films, or integrated solid or semi-hollow dielectric materials within the first or second insulating layers (206A, 206B). The gap can be tunable or adjustable or replaced by a dielectric material of selected thickness and permittivity, allowing for user, manufacturer, or automated adjustment to tune or establish a set gap size for a set performance level.

In various embodiments, flexible component 112 may be deployed in multiple configurations or implementations of wearable devices that interface with a user's body and operatively connect to a smart device (e.g., a smart watch, smart glasses, smart ring, smart phone or any other wireless communication device). For example, flexible component 112 may be implemented as a wrist band configured to be worn around a user's wrist, such as a wrist band of a smart watch. For example, flexible component 112 can be integrated into a temple portion of a pair of smart glasses, or disposed within a neck band configured to be coupled with smart glasses. For instance, the flexible component 112 can be embedded within an article of clothing, adhered to a user's skin as an electronic skin or patch, or incorporated into a flexible substrate positioned proximate to a joint, such as a knee or ankle, for motion or physiological monitoring, or any wearable structure configured to interface with a portion of a user's body and provide antenna signaling for a smart device.

Based on implementations, the architecture for signal propagation within the antenna package 114 can accommodate various types of antenna excitation via any type of a feed structure 208 for direct, aperture, capacitive, or inductive signal coupling. The architecture can include multiple antenna contacts, which can be used interchangeably as the signal feed contact and the ground contact. These and other contacts can be matched or tuned (e.g., for impedance, frequency, signal strength, phase or any other signal characteristic) using various electrical components 212 of the circuitry layer 210, such as various inductive and capacitive (L/C) components. The antenna package body material can include a low-loss dielectric material having a dielectric constant of less than 4. The package body can be configured as a shape that is hollowed (e.g., include air pockets of particular shape) to help reduce RF loss and provide a desired distance or separation from the back plane layer 116. Depending on the implementation, certain features, such as the air gap size between the insulating layer 206 supporting the antenna layer 202 and the pads layer 216 or the back plane layer 116, can be adjusted or fine-tuned.

Technical solutions for an antenna-in-package can leverage the advantages of a discrete, independent module including a compact antenna with its own integrated RF signal matching circuitry layer 210. The circuitry of the circuitry layer 210 can support independent tuning of the transmitted or received antenna signals, and can include passive or low-power components, such as RF front-end switches and filters to conserve space in the wearable wireless device and minimize RF losses. The antenna-in package can include electrical pads 218 operating as test and ground pads, making the package suitable for soldering or mechanical alignment and snap-in placement and connection, facilitating detachable connectivity and independent testing or tuning independently from the other elements of the wearable device system. The matching and RF circuitries can be adjusted, tuned and controlled via external power management through dedicated tuning pads (e.g., electrical pads 218) on the module. The signals received via the tuning pads can be used to enable, disable or control operation of certain circuits in the circuitry layer 210 allowing for adjustments and tuning in the RF signal filtering, amplification and impedance matching. Antenna feed structure 208 can be configured to facilitate any antenna excitation, including direct excitation, aperture excitation, parasitic coupling, inductive, or capacitive coupling and techniques. The antenna package 114 can be used in coordination with a back plane layer 116, or a part of one or more back plane layers 116, as a single antenna, a set of multiple antennas, or as part of an antenna array, and multiple such modules can similarly work together in flexible configurations.

Depending on implementation, antenna packages 114 can include low-loss dielectric materials for the insulating layer to adjust or improve the RF performance, as well as multi-layer flexible stack-ups that can accommodate repeated mechanical flexing and environmental exposure. The flexible component 112 (e.g., a wrist band) can be constructed to encapsulate and seal the antenna packages 114, protecting the packages from moisture, sweat, and mechanical stress, while providing electrical isolation between the antenna and the user through intervening back plane and band materials.

FIG. 3 illustrates an example circuitry 300 for implementing a radio frequency (RF) front end processing in an antenna package 114. The example circuitry 300 of FIG. 3 can be implemented across different layers of the antenna package 114, including a circuitry layer 210 and an antenna layer 202. The example circuitry 300 can include an RF ground terminal 302 and an RF signal terminal 304 for receiving antenna signals to be transmitted from a wireless wearable device and providing antenna signals to the wireless wearable device. The RF ground terminal and RF signal terminal can each be implemented as electrical pads 218 at the pads layer 216 of the antenna package 114.

The example circuitry 300 can have the RF ground terminal 302 and the RF signal terminal 304 electrically couple with the one or more RF components 306 configured for antenna signal RF front end processing. The RF components 306 (which can include electrical components 212 of the circuitry layer 210) can process the receiving or transmitting antenna signals can be coupled with an antenna connector 308, which can also be coupled with the RF ground terminal 302. The antenna connector 308 can be coupled with an antenna aperture matching 310 and antenna feed matching 312 components, which can connect to the antenna pattern 204 operating as the antenna radiation element for transmitting and receiving antenna signals.

The circuitry architecture 300 of FIG. 3 supports both the reception and transmission of the antenna signals to and from the wireless wearable device. For instance, a received antenna signal entering, coupling with or electrically exciting the antenna pattern 204 (e.g., the antenna radiation element) can traverse the antenna feed matching circuitry 312 and the antenna aperture matching circuitry 310. The antenna feed matching circuitry 312 and the antenna aperture matching circuitry 310 can condition the impedance and frequency responses conditioned to maximize energy transfer for the intended communication protocol. The conditioned signal processed by the antenna aperture matching 310 and the antenna feed matching 312 can be provided to the antenna connector 308, which can provide an electrically controlled interface to the main body of the antenna package 114, and then to the one or more RF components 306.

The RF components 306, which can include any electrical components 212, can include, any arrangement of amplifiers, filters, switches, impedance matching elements, or adaptive tuning devices, each configured to process the received signal according to the requirements of multi-band, multi-protocol wireless operation. The signal processing can depend on whether the antenna signal is a signal to be transmitted or a signal to be received. Upon processing the signal in the RF front end, the output signal from the RF components 306 can be routed to the RF signal terminal 304 and the RF ground terminal 302, which can be implemented as electrically conductive electrical pads 218 coupled with the electrical conductors 220.

For signal transmission from the wearable device, the signal path can run in reverse, as the antenna signal to be transmitted is provided to the RF signal terminal 304 enter the RF components 306, via the electrical conductors 220 at the back plane layer 116. Once received by the RF front end RF components 306 the antenna signals can be subject to any amplification, filtering, impedance matching, or frequency selection, and delivered through the antenna connector 308 and associated matching circuitry to the antenna pattern 204 for transmission.

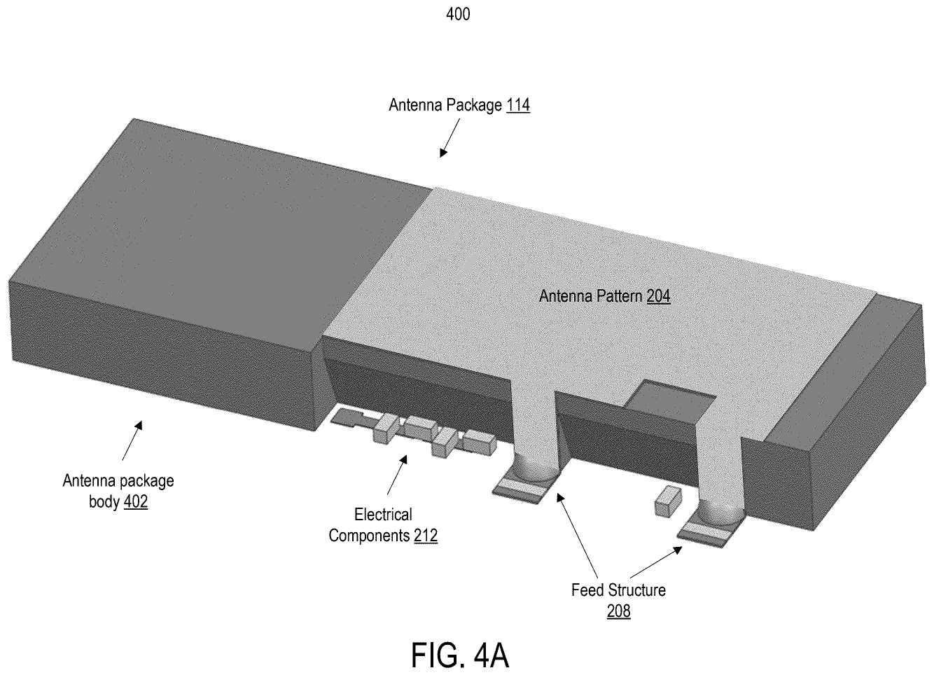

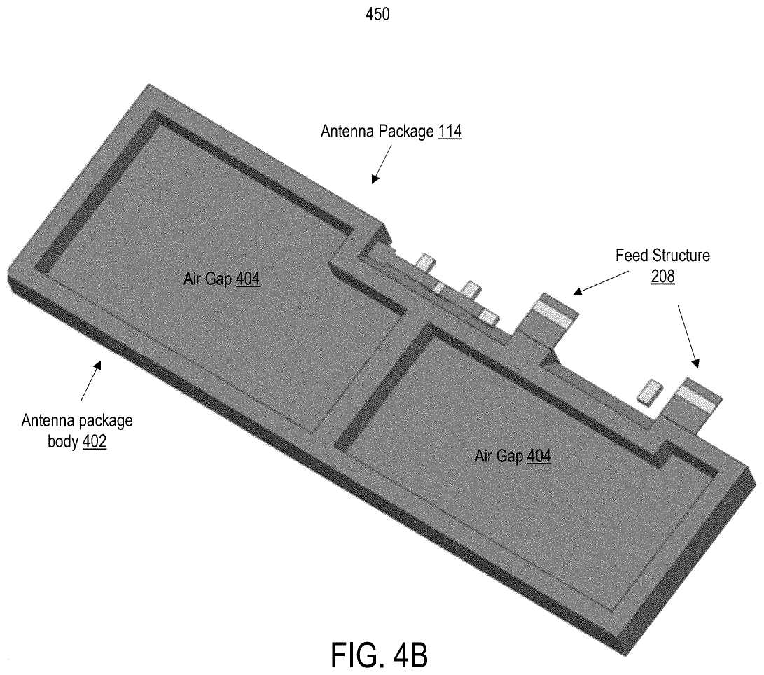

FIGS. 4A and 4B illustrate perspective views 400 and 450 of an example antenna package 114 implemented on an antenna package body 402. The antenna package body 402 can include a shape or a structure implemented in a dielectric material or a substrate to provide a structure or a shape for optimizing the performance of the antenna package 114. As shown in the perspective view 400 of FIG. 4A, the antenna package 114 can provide an antenna pattern 204 if the antenna layer at a top surface of the antenna package body 402. The antenna package body 402 shown in FIGS. 4A and 4B is shaped as a rectangular cuboid or a rectangular prism, but it is understood that antenna package body 402 can be shaped any other way, including for example a cube, a cylindrical shape, a rounded or elliptical prism, a triangular prism, a dome, a curved surface, a wedge, or an irregular or custom-contoured form designed to conform to the ergonomic shape of a wearable band, temple, or body-adjacent structure.

As shown in the perspective view 450 of FIG. 4B illustrating a bottom view of the same antenna package 114 shown in view 400, the antenna package body 402 can be at least partially hollowed or etched out through the bottom surface. The hollowed or etched out portion of the antenna package body 402 can form one or more air compartments providing one or more air gaps 404. The size and shape of the hollowed out compartment forming the air gap can be configured according to design threshold parameters for the size of electrical and electromagnetic insulation and spacing between the antenna pattern 204 and other components, such as the back plane layer 116, electrical pads 218, electrical conductors 220 or electrical components 212.

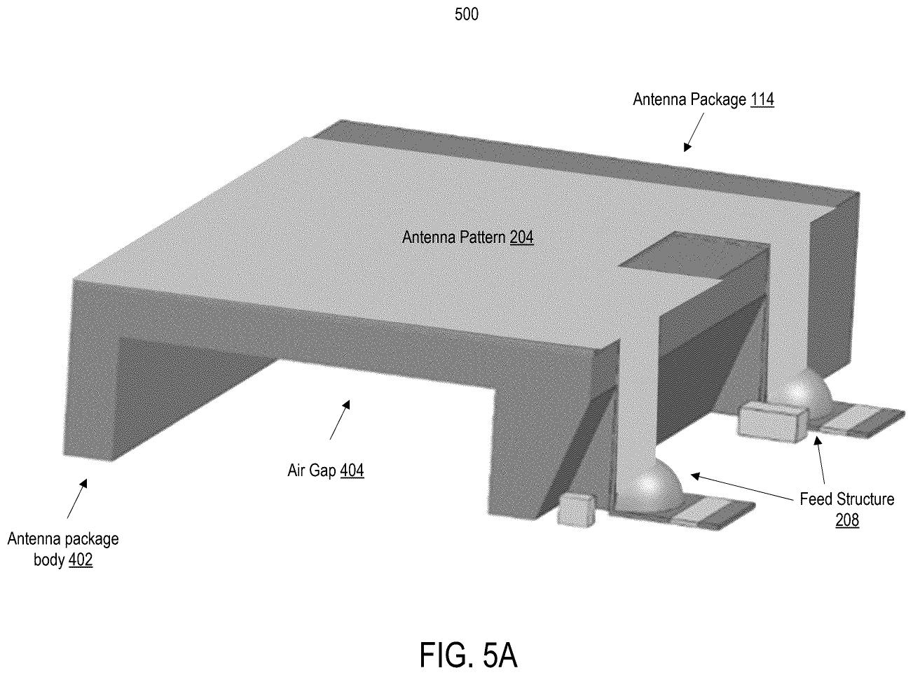

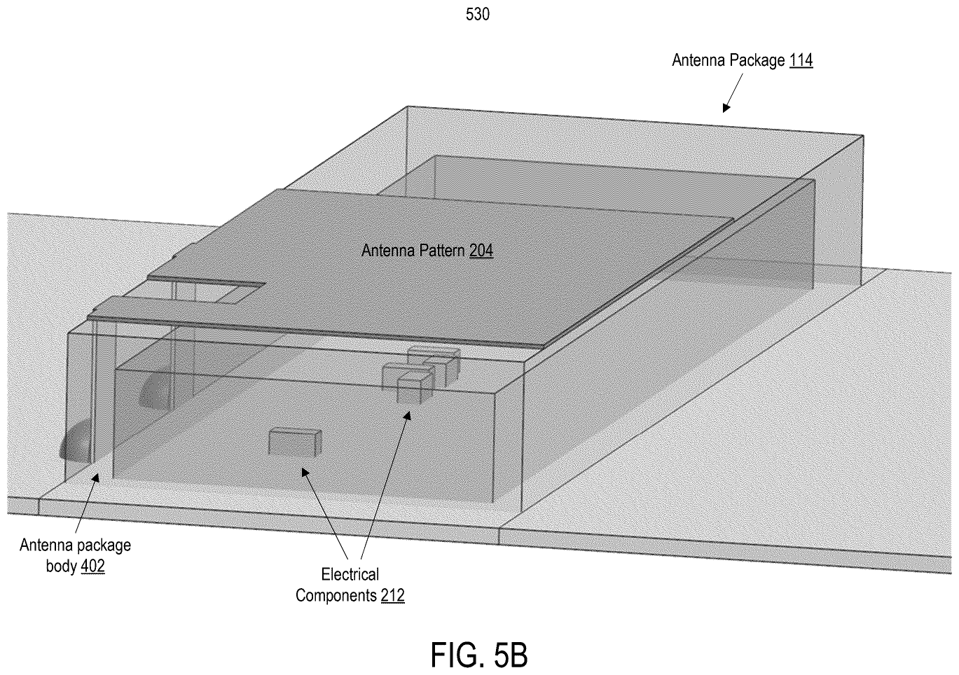

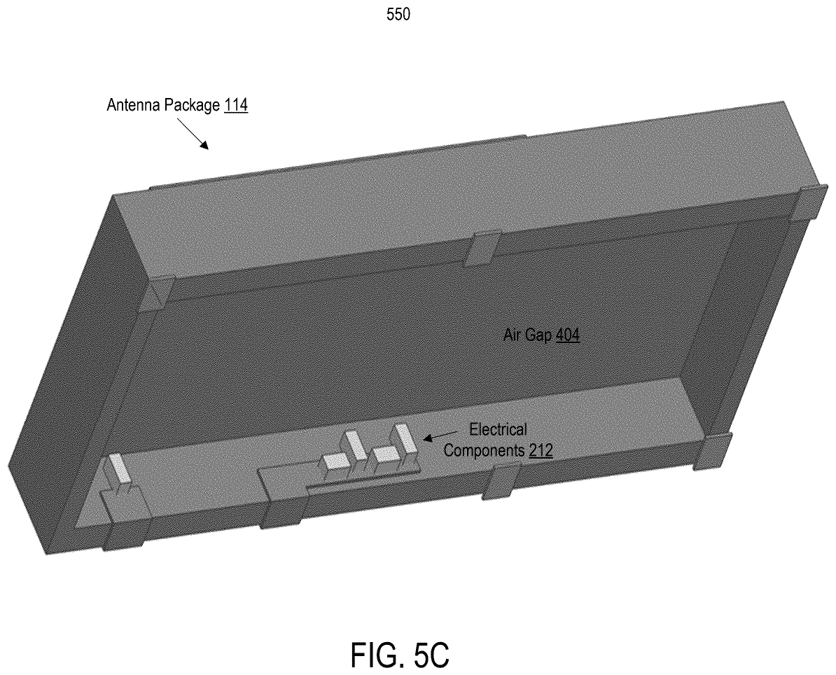

Referring now to FIGS. 5A, 5B and 5C and their corresponding perspective views 500, 530 and 550, an example antenna package body 402 with a hollow cavity providing an air gap, is illustrated. The hollowed out antenna package body 402 can be formed as a rectangular cuboid whose bottom side and the two sides that are both adjacent to the bottom side and opposite to each other are each hollowed out to form a cavity forming an air gap 404. As shown in the perspective view 500 of FIG. 5A, the antenna pattern 204 is disposed on the top surface of the antenna package body 402. The feed structure 208 includes electrical contacts that are disposed on a side of the body with the antenna pattern 204 that is not hollowed out. Beneath the side of the antenna package body 402 that carries the antenna pattern 204, a hollowed out compartment forms an air gap 404 of a particular air gap size. Shown in perspective view 530 of FIG. 5B, the antenna package 114 and the antenna pattern 204 can be disposed on the antenna package body 402 beneath which the compartment with the air gap can include electrical components 212. Shown in perspective view 550 of FIG. 5C, the antenna package 114 can include a compartment hollowed out in the bottom or base surface of the body providing an air gap 404. On the interior surface of the sidewall of the compartment, one or more electrical components 212 can be provided for processing the antenna signals.

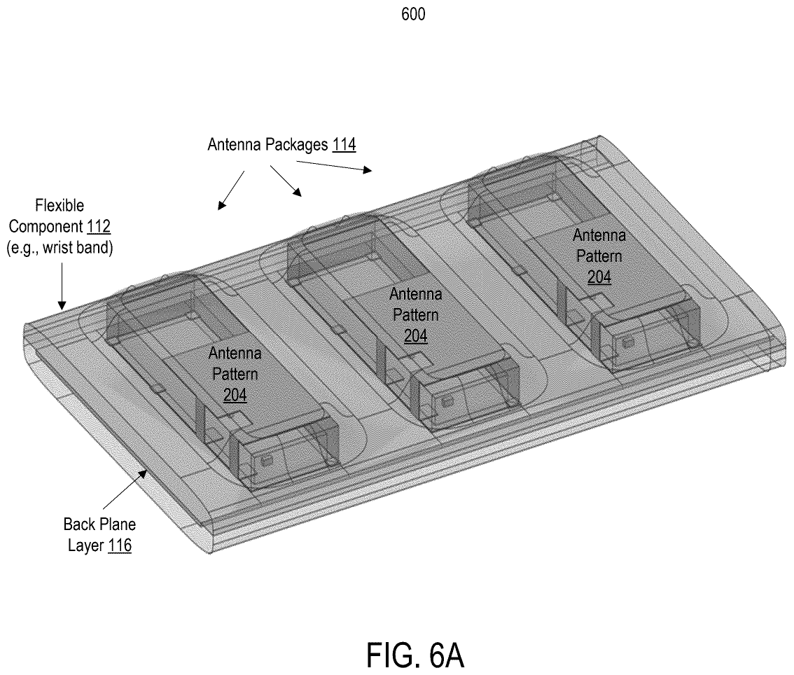

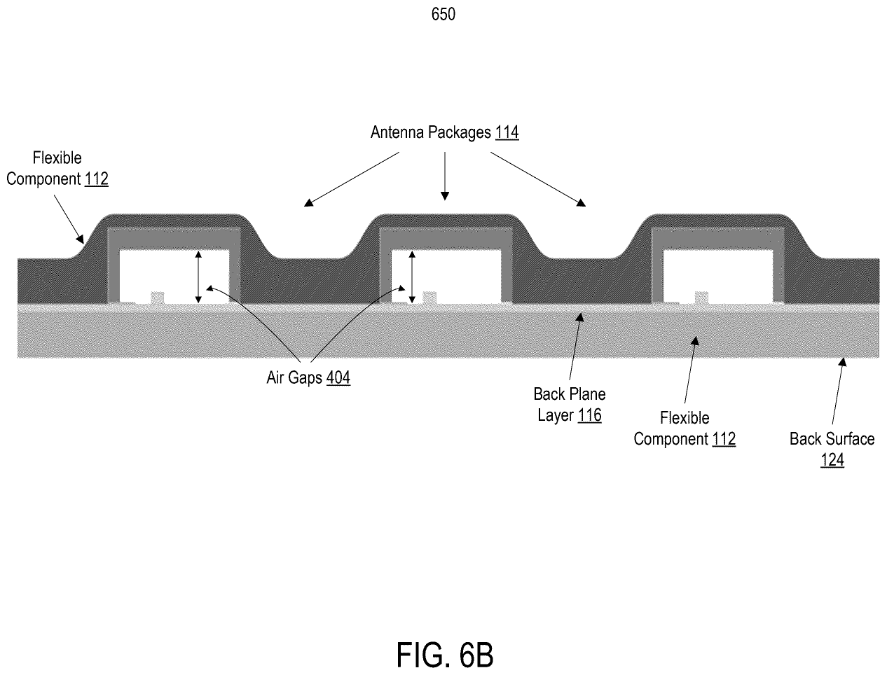

Referring now to FIGS. 6A and 6B, a perspective view 600 and a cross-sectional view 650 illustrate a plurality of antenna packages 114 disposed within a flexible component 112. As shown in a view 600 of FIG. 6A, an array of antenna packages 114 can be disposed on a back plane layer 116 within a flexible component 112 (e.g., a wrist band) of a wearable device. The antenna packages 114 can be formed with hollow antenna package bodies 402 forming a cavity or an internal compartments providing air gaps 404. Antenna packages 114 can include their own antenna layers with antenna patterns 204 suitable for a particular one or more wireless technologies or protocols.

As shown in the cross-sectional view 650 of FIG. 6B, the antenna packages 114 can include air gaps 404 and can be entirely enclosed or sealed within the flexible component 112. The flexible component 112 can include a first material or a portion onto which the back plane layer 116 is disposed and which forms the back surface 124 for interfacing with the user's body. The flexible component 112 can include a second material or a portion that covers or seals the antenna packages 114 and the back plane layer 116 from the top side.

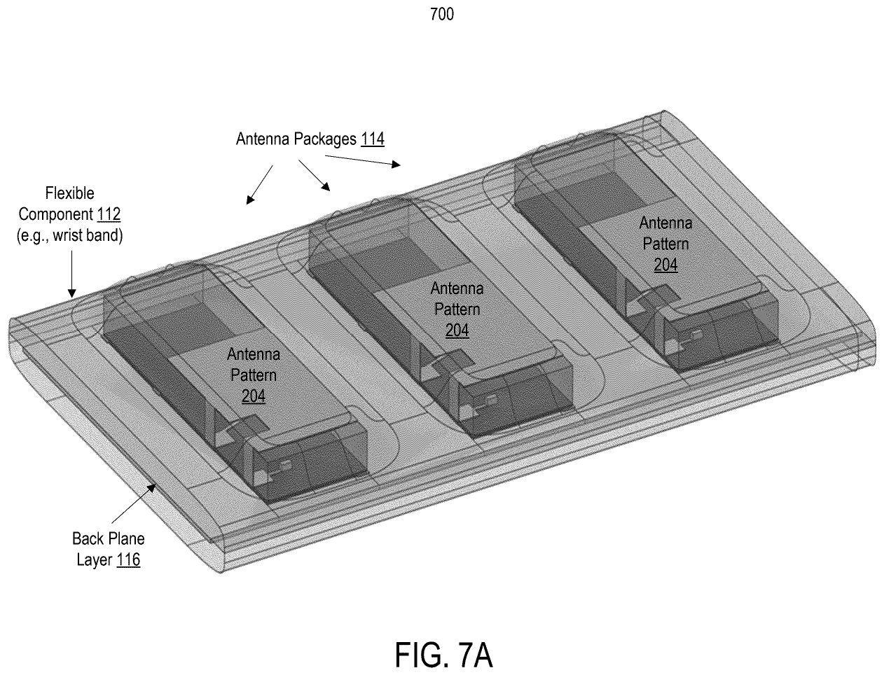

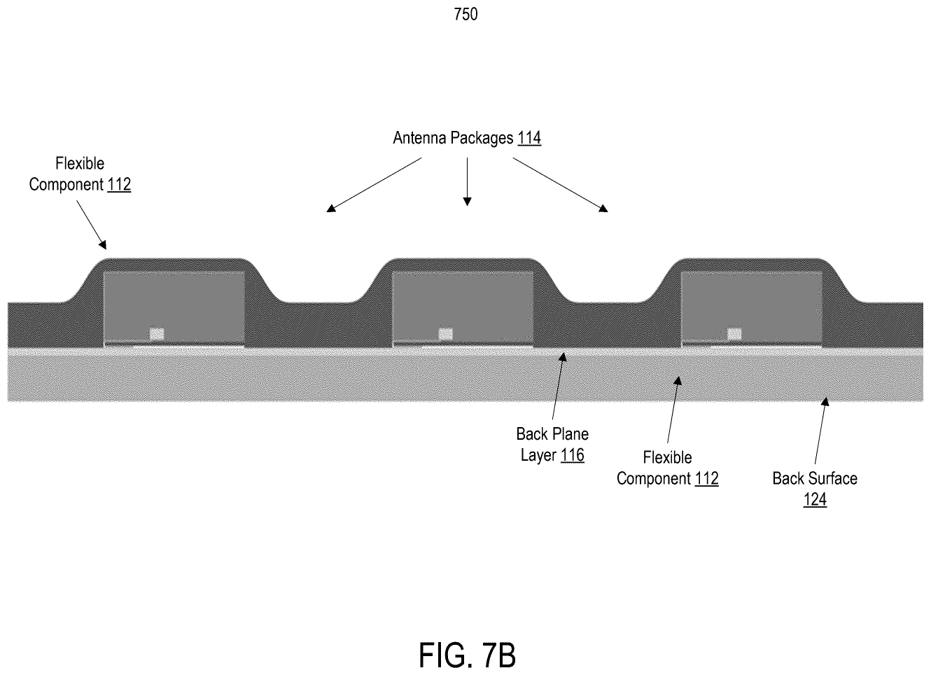

Referring now to FIGS. 7A and 7B, a perspective view 700 and a cross-sectional view 750 illustrate a plurality of antenna packages 114 disposed within a flexible component 112. As shown in a view 700 of FIG. 7A, an array of antenna packages 114 can be disposed on a back plane layer 116 within a flexible component 112 (e.g., a wrist band) of a wearable device. The antenna packages 114 can be formed with solid antenna package bodies 402. Antenna packages 114 can include their own antenna layers with antenna patterns 204 suitable for a particular one or more wireless technologies or protocols.

As shown in the cross-sectional view 750 of FIG. 7B, the antenna packages 114 can include a solid body material without air gaps and can be entirely enclosed or sealed within the flexible component 112. The flexible component 112 can include a first material or a portion onto which the back plane layer 116 is disposed and which forms the back surface 124 for interfacing with the user's body and a second material or a portion that covers or seals the antenna packages 114 and the back plane layer 116 from the top side.

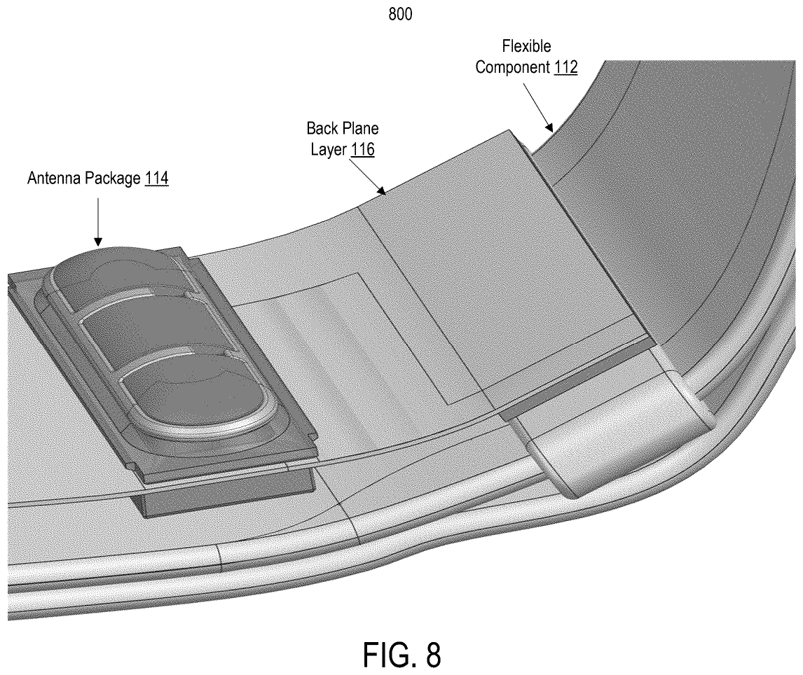

FIG. 8 illustrates an example configuration 800 of a flexible component 112 having an antenna package 114 and a back plane layer 116 that are exposed and aligned with a back surface 124 interfacing with the user's body. As shown in example configuration 800, the antenna package 114 can be provided disposed on a back plane layer 116 which can double as the back surface 124 interfacing with the user. The flexible component 112 can carry the back plane on its outer surface, depending on the implementation.

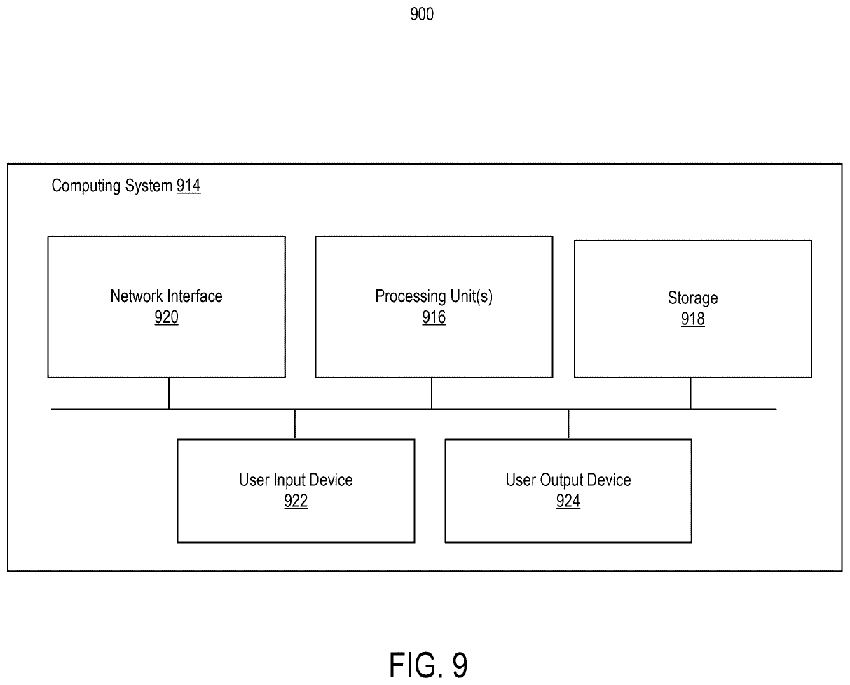

Referring now to FIG. 9, various operations or functionality features described herein can be implemented on computer systems, such as those utilized in a wearable wireless device. FIG. 9 shows a block diagram of an example computing system 914 that can be used to implement various features of the present disclosure. In some embodiments, a wireless communication device or a user equipment (e.g., a smart watch or smart glasses) can be implemented, at least in part, using a computing system 914. Computing system 914 can be implemented, for example, as a part of any consumer device such as a smartphone, other mobile phone, tablet computer, wearable computing device (e.g., smart watch, eyeglasses, head wearable display), desktop computer, laptop computer, or implemented with distributed computing devices. The computing system 914 can be implemented to provide augmented or virtual reality experience, or to implement wireless communication, such as communication over a cellular network (e.g., Wi-Fi, Bluetooth, 4G or 5G network). In some embodiments, the computing system 914 can include conventional computer components such as processors 916, storage device 918, network interface 920, user input device 922, and user output device 924.

Computing system 914 can include one or more processing units 916 (e.g., digital signal processors, microprocessors, system on a chip integrated circuits, media processors, graphics processors, microcontrollers and others). Processing units 916 can include or be coupled with memory, such as read only memory (ROM), random access memory (RAM), static RAM (SRAM), dynamic RAM (DRAM) or flash memory. Memory can store instructions or commands for operating the processors 916.

Network interface 920 can provide a connection to a wide area network (e.g., the Internet) to which WAN interface of a remote server system is also connected. Network interface 920 can include a wired interface (e.g., Ethernet) and/or a wireless interface implementing various RF data communication standards such as Wi-Fi, Bluetooth, or cellular data network standards (e.g., 3G, 4G, 5G, 60 GHz, Bluetooth, GNSS, LTE, NR, UWB etc.).

User input device 922 can include any device (or devices) via which a user can provide signals to computing system 914. The computing system 914 can interpret the signals as indicative of particular user requests or information. User input device 922 can include any or all of a keyboard, touch pad, touch screen, mouse or other pointing device, scroll wheel, click wheel, dial, button, switch, keypad, microphone, sensors (e.g., a motion sensor, an eye tracking sensor, etc.), memory (e.g., read only memory (ROM), random access memory (RAM), static RAM (SRAM), dynamic RAM (DRAM), flash memory) and so on.

User output device 924 can include any device via which computing system 914 can provide information to a user. For example, user output device 924 can include a display to display images generated by or delivered to computing system 914. The display can incorporate various image generation technologies, e.g., a liquid crystal display (LCD), light-emitting diode (LED) including organic light-emitting diodes (OLED), projection system, cathode ray tube (CRT), or the like, together with supporting electronics (e.g., digital-to-analog or analog-to-digital converters, signal processors, or the like). A device such as a touchscreen that function as both input and output device can be used. Output devices 924 can be provided in addition to or instead of a display. Examples include indicator lights, speakers, tactile “display” devices, printers, and so on.

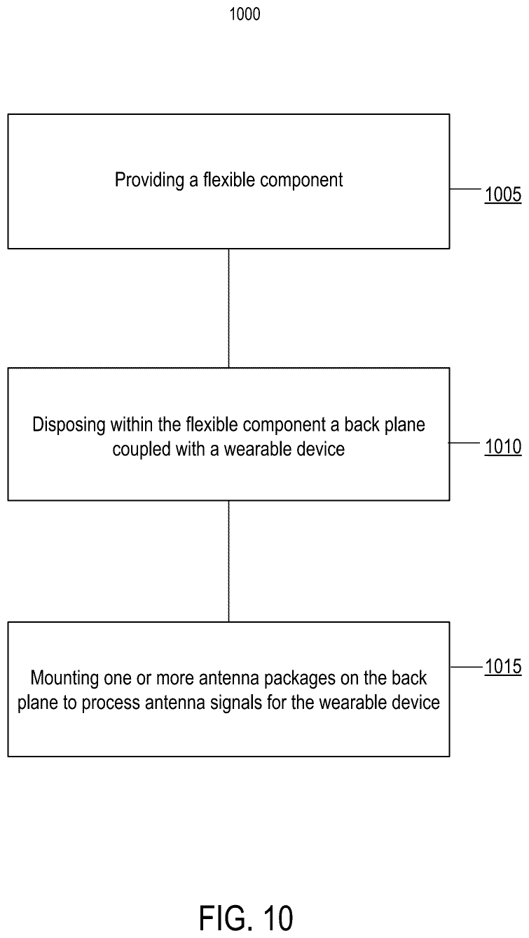

FIG. 10 illustrates an example flowchart of a method 1000 for providing a wearable device with a flexible component comprising antenna packages. The method 1000 can be implemented using any features or characteristics described in connection with FIGS. 1-9. The method 1000 can include acts 1005-1015. At act 1005, the method can include providing a flexible component. At act 1010, the method can include disposing withing the flexible component a back plane coupled with a wearable device. At act 1015, the method can include mounting one or more antenna packages on the back plane to process antenna signals for the wearable device.

At act 1005, the method can include providing a flexible component. Providing a flexible component can include selecting or manufacturing a component having sufficient flexibility, durability, and ergonomic properties to function as part of a wearable device. The method can include forming the flexible component from materials such as silicone rubber, polyurethane, polyimide, thermoplastic elastomers, or woven or synthetic fabrics. The flexible component can be configured with internal cavities, channels, or recesses for the integration of electronic subassemblies (e.g., antenna packages and back plane layer or electrical conductor lines), and may incorporate protective coatings, reinforcements, or decorative surface treatments.

The method can include providing flexible component that includes one of a wrist band of a smart watch device or a neck band or a temple of a smart glasses device. Providing a flexible component can include designing structural features to support user comfort, secure fit, and environmental protection of internal electronics. In some examples, providing a flexible component can include forming dedicated regions or mounting surfaces for placement and alignment of antenna packages or conductive pathways, such as placing a back plane layer between antenna packages and a surface of the flexible component interfacing with the user. Providing a flexible component can include manufacturing the component using molding, extrusion, lamination, or additive fabrication techniques to accommodate complex shapes or multi-layer assemblies.

At act 1010, the method can include disposing withing the flexible component a back plane coupled with a wearable device. The method can include disposing an electrical conductor material of a back plane layer along a length of the flexible component. The flexible component can be mechanically coupled with a wearable device. The back plane layer can be configured to one at least one of: reflect, direct or attenuate one or more body effects of the user. For instance, the back plane layer can reflect, direct, or attenuate electromagnetic effects arising from proximity between the antenna system and the user's body, improving antenna efficiency and reducing body-induced detuning or signal loss. Disposing the back plane can include providing contact points or interface regions for electrical coupling to other assemblies or antenna packages within the wearable device.

Disposing an electrical conductor material of a back plane layer along a length of the flexible component can include positioning, inserting, or integrating a metallic or conductive polymer sheet, mesh, or patterned trace to form the back plane layer within the flexible component. The flexible component can be coupled with a wearable device through attachment mechanisms, mechanical fit, electrical connectors, or integrated assembly methods that secure the flexible component and provide electrical interfacing with the wearable device's main circuitry. The method can include fixing the back plane layer in such a manner that it extends continuously or discontinuously along all or part of the flexible component, allowing for signal routing and electrical connectivity. Disposing the electrical conductor of the back plane can include aligning the back plane layer in relation to antenna package positions as well as cavities or mounting regions in the flexible component.

At act 1015, the method can include mounting one or more antenna packages on the back plane to process antenna signals for the wearable device. The method can include mounting, onto the back plane layer, one or more antenna packages. The one or more antenna packages can include an antenna package that includes an insulating layer comprising a dielectric material disposed above at least a portion of the electrical conductor material of the back plane layer. The antenna package can include a circuitry layer disposed above at least a portion of the insulating layer and comprising one or more electrical components for processing antenna signals. The antenna package can include an antenna layer comprising an antenna pattern disposed above at least a portion of the circuitry layer and configured for wireless communication of the antenna signals using the wearable device. The back plane layer can be disposed between antenna layer and a surface of the flexible component configured to interface with a user wearing the wearable device.

The mounted antenna package can include a pads layer disposed above at least a portion of the electrical conductor material of the back plane layer and beneath at least a portion of the insulating layer. The pads layer can include one or more electrical pads configured for at least one of testing of the antenna package, tuning of a frequency response of the antenna package or electrical coupling the antenna patterns with one or more electrical conductors disposed beneath the antenna package and leading to the wearable device. For example, the antenna package can also include a second insulating layer disposed above at least a portion of the circuitry layer and beneath at least a portion of the antenna layer. The second insulating layer can provide electrical insulation between the one or more electrical components and the antenna pattern. For instance, the dielectric material of the insulating layer or the second insulating layer can include a dielectric constant that is less than 4 and the electrical conductor material of the back plane layer can include a metal.

The method can include configuring the antenna package to receive or transmit the antenna signals according to a wireless communication technology of a plurality of wireless communication technologies communicated using the wearable device. For example, the wireless communication technology can include one of: 5G new radio (NR), Long Term Evolution (LTE), narrow band Internet of Things (NB-IoT), Bluetooth, Bluetooth Low Energy (BLE), Wi-Fi, Near Field Communication (NFC), Ultra-Wideband (UWB), Global Navigation Satellite System (GNSS) communication, Zigbee, ANT wireless technology (ANT), and Long Range (LoRa).

The method can include setting, establishing or providing a distance gap between the insulating layer and the back plane layer. The distance gap can be established, set or selected based on a type of wireless communication for which the antenna package is configured. For example, the distance gap can be configured to decrease at least one of detuning, attenuation, or signal loss arising from proximity to the user. The method can include providing the one or more electrical components that comprise one or more of a radio-frequency switch, a variable capacitor, a tunable inductor, an amplifier, a filter, or an amplifier. The method can include arranging one or more electrical components to provide one of a radio-frequency matching, signal filtering, impedance matching or signal conditioning of the antenna signals transmitted or received via the antenna package.

The method can include mounting, onto back plane layer, a second antenna package spaced apart from the antenna package. The second antenna package can include a second insulating layer comprising a second dielectric material disposed above at least a second portion of the electrical conductor material of the back plane layer. For example, the second antenna package can include a second circuitry layer disposed above at least a portion of the second insulating layer and comprising one or more components for processing second antenna signals. The second antenna package can include a second antenna layer comprising a second antenna pattern disposed above at least a portion of the second circuitry layer and configured for wireless communication of the second antenna signals using the wearable device. For instance, the second antenna package can be configured to communicate antenna signals in a second one or more frequency bands of a second wireless communication technology that is different from a first one or more frequency bands of a first wireless communication technology which the antenna package is configured to communicate.

The antenna package and the second antenna package can each include one or more feed structures that can include at least one of: a direct feed, an aperture feed, a capacitive coupling, or an inductive coupling. For instance, the feed structures can be implemented via at least the insulating layer and the circuitry layer. The antenna package can be configured to operate as a part of a plurality of antenna packages disposed on a front surface of the back plane layer that is opposite to a back surface of the back plane layer that faces the surface of the flexible component configured to interface with the user. Each antenna package of the plurality of antenna packages can be electrically coupled with the wearable device via one or more electrical conductor lines at least partly disposed along the front surface of the back plane layer. For example, the method can include forming the surface of the flexible component that is configured to interface with the user using a material disposed between the back plane layer and the surface of the back plane. The material of the flexible component can enclose the antenna package within the flexible component to protect the antenna package from an external element.

The method can include defining, by a dielectric material of the insulating layer of the antenna package, a body of the antenna package. The method can include forming the body of the antenna package to comprise a body portion onto which the antenna layer is disposed and to provide an air gap between the body portion and the back plane layer. For example, the body of the antenna package can form a size of the air gap of the antenna package that is configured for a first wireless communication technology. This size can be different than a second size of a second air gap between a second body portion of a second antenna package and the back plane layer, as the second size of the second air gap can be selected according to a second wireless communication technology of the second antenna package. The second wireless technology (e.g., Wi-Fi or Bluetooth) can be different than a first wireless communication technology (e.g., LTE or NR) of the antenna package for which the size of the air gap of the antenna package is selected.

The method can include providing on a bottom side of the antenna package one or more electrical contacts that can interface with the back plane layer. For instance, the one or more electrical contacts can be configured to electrically connect the antenna package to a corresponding one or more contacts on the back plane layer. For instance, the antenna package can be removed from the flexible component and replaced with another antenna package while the back plane layer remains with the flexible component.

Some implementations include electronic components, such as microprocessors, storage and memory that store computer program instructions in a computer readable storage medium (e.g., non-transitory computer readable medium). Many of the features described in this specification can be implemented as processes that are specified as a set of program instructions encoded on a computer readable storage medium. When these program instructions are executed by one or more processors, they cause the processors to perform various operation indicated in the program instructions. Examples of program instructions or computer code include machine code, such as is produced by a compiler, and files including higher-level code that are executed by a computer, an electronic component, or a microprocessor using an interpreter. Through suitable programming, processor 316 can provide various functionality for computing system 314, including any of the functionality described herein as being performed by a server or client, or other functionality associated with message management services.

It will be appreciated that computing system 314 is illustrative and that variations and modifications are possible. Computer systems used in connection with the present disclosure can have other capabilities not specifically described here. Further, while computing system 314 is described with reference to particular blocks, it is to be understood that these blocks are defined for convenience of description and are not intended to imply a particular physical arrangement of component parts. For instance, different blocks can be located in the same facility, in the same server rack, or on the same motherboard. Further, the blocks need not correspond to physically distinct components. Blocks can be configured to perform various operations, e.g., by programming a processor or providing appropriate control circuitry, and various blocks might or might not be reconfigurable depending on how the initial configuration is obtained. Implementations of the present disclosure can be realized in a variety of apparatus including electronic devices implemented using any combination of circuitry and software.

Having now described some illustrative implementations, it is apparent that the foregoing is illustrative and not limiting, having been presented by way of example. In particular, although many of the examples presented herein involve specific combinations of method acts or system elements, those acts and those elements can be combined in other ways to accomplish the same objectives. Acts, elements and features discussed in connection with one implementation are not intended to be excluded from a similar role in other implementations or implementations.

The hardware and data processing components used to implement the various processes, operations, illustrative logics, logical blocks, modules and circuits described in connection with the embodiments disclosed herein may be implemented or performed with a general purpose single- or multi-chip processor, a digital signal processor (DSP), an application specific integrated circuit (ASIC), a field programmable gate array (FPGA), or other programmable logic device, discrete gate or transistor logic, discrete hardware components, or any combination thereof designed to perform the functions described herein. A general purpose processor may be a microprocessor, or any conventional processor, controller, microcontroller, or state machine. A processor also may be implemented as a combination of computing devices, such as a combination of a DSP and a microprocessor, a plurality of microprocessors, one or more microprocessors in conjunction with a DSP core, or any other such configuration. In some embodiments, particular processes and methods may be performed by circuitry that is specific to a given function. The memory (e.g., memory, memory unit, storage device, etc.) may include one or more devices (e.g., RAM, ROM, Flash memory, hard disk storage, etc.) for storing data and/or computer code for completing or facilitating the various processes, layers and modules described in the present disclosure. The memory may be or include volatile memory or non-volatile memory, and may include database components, object code components, script components, or any other type of information structure for supporting the various activities and information structures described in the present disclosure. According to an exemplary embodiment, the memory is communicably connected to the processor via a processing circuit and includes computer code for executing (e.g., by the processing circuit and/or the processor) the one or more processes described herein.

The present disclosure contemplates methods, systems and program products on any machine-readable media for accomplishing various operations. The embodiments of the present disclosure may be implemented using existing computer processors, or by a special purpose computer processor for an appropriate system, incorporated for this or another purpose, or by a hardwired system. Embodiments within the scope of the present disclosure include program products comprising machine-readable media for carrying or having machine-executable instructions or data structures stored thereon. Such machine-readable media can be any available media that can be accessed by a general purpose or special purpose computer or other machine with a processor. By way of example, such machine-readable media can comprise RAM, ROM, EPROM, EEPROM, or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. Combinations of the above are also included within the scope of machine-readable media. Machine-executable instructions include, for example, instructions and data which cause a general purpose computer, special purpose computer, or special purpose processing machines to perform a certain function or group of functions.

The phraseology and terminology used herein is for the purpose of description and should not be regarded as limiting. The use of “including” “comprising” “having” “containing” “involving” “characterized by” “characterized in that” and variations thereof herein, is meant to encompass the items listed thereafter, equivalents thereof, and additional items, as well as alternate implementations consisting of the items listed thereafter exclusively. In one implementation, the systems and methods described herein consist of one, each combination of more than one, or all of the described elements, acts, or components.

Any references to implementations or elements or acts of the systems and methods herein referred to in the singular can also embrace implementations including a plurality of these elements, and any references in plural to any implementation or element or act herein can also embrace implementations including only a single element. References in the singular or plural form are not intended to limit the presently disclosed systems or methods, their components, acts, or elements to single or plural configurations. References to any act or element being based on any information, act or element can include implementations where the act or element is based at least in part on any information, act, or element.

Any implementation disclosed herein can be combined with any other implementation or embodiment, and references to “an implementation,” “some implementations,” “one implementation” or the like are not necessarily mutually exclusive and are intended to indicate that a particular feature, structure, or characteristic described in connection with the implementation can be included in at least one implementation or embodiment. Such terms as used herein are not necessarily all referring to the same implementation. Any implementation can be combined with any other implementation, inclusively or exclusively, in any manner consistent with the aspects and implementations disclosed herein.

Where technical features in the drawings, detailed description or any claim are followed by reference signs, the reference signs have been included to increase the intelligibility of the drawings, detailed description, and claims. Accordingly, neither the reference signs nor their absence have any limiting effect on the scope of any claim elements.

Systems and methods described herein may be embodied in other specific forms without departing from the characteristics thereof. References to “approximately,” “about” “substantially” or other terms of degree include variations of +/−10% from the given measurement, unit, or range unless explicitly indicated otherwise. Coupled elements can be electrically, mechanically, or physically coupled with one another directly or with intervening elements. Scope of the systems and methods described herein is thus indicated by the appended claims, rather than the foregoing description, and changes that come within the meaning and range of equivalency of the claims are embraced therein.

The term “coupled” and variations thereof includes the joining of two members directly or indirectly to one another. Such joining may be stationary (e.g., permanent or fixed) or moveable (e.g., removable or releasable). Such joining may be achieved with the two members coupled directly with or to each other, with the two members coupled with each other using a separate intervening member and any additional intermediate members coupled with one another, or with the two members coupled with each other using an intervening member that is integrally formed as a single unitary body with one of the two members. If “coupled” or variations thereof are modified by an additional term (e.g., directly coupled), the generic definition of “coupled” provided above is modified by the plain language meaning of the additional term (e.g., “directly coupled” means the joining of two members without any separate intervening member), resulting in a narrower definition than the generic definition of “coupled” provided above. Such coupling may be mechanical, electrical, or fluidic.

References to “or” can be construed as inclusive so that any terms described using “or” can indicate any of a single, more than one, and all of the described terms. A reference to “at least one of ‘A’ and ‘B’” can include only ‘A’, only ‘B’, as well as both ‘A’ and ‘B’. Such references used in conjunction with “comprising” or other open terminology can include additional items.

Modifications of described elements and acts such as variations in sizes, dimensions, structures, shapes and proportions of the various elements, values of parameters, mounting arrangements, use of materials, colors, orientations can occur without materially departing from the teachings and advantages of the subject matter disclosed herein. For example, elements shown as integrally formed can be constructed of multiple parts or elements, the position of elements can be reversed or otherwise varied, and the nature or number of discrete elements or positions can be altered or varied. Other substitutions, modifications, changes and omissions can also be made in the design, operating conditions and arrangement of the disclosed elements and operations without departing from the scope of the present disclosure.

References herein to the positions of elements (e.g., “top,” “bottom,” “above,” “below”) are merely used to describe the orientation of various elements in the FIGURES. The orientation of various elements may differ according to other exemplary embodiments, and that such variations are intended to be encompassed by the present disclosure.

What is claimed is:

1. A system, comprising:
a flexible component coupled with a wearable device, the flexible component comprising:
a back plane layer comprising an electrical conductor material disposed along a length of the flexible component; and
an antenna package, comprising:
an insulating layer comprising a dielectric material disposed above at least a portion of the electrical conductor material of the back plane layer;
a circuitry layer disposed above at least a portion of the insulating layer and comprising one or more electrical components for processing antenna signals; and
an antenna layer comprising an antenna pattern disposed above at least a portion of the circuitry layer and configured for wireless communication of the antenna signals using the wearable device, wherein the back plane layer is disposed between antenna layer and a surface of the flexible component configured to interface with a user wearing the wearable device.

2. The system of claim 1, wherein the flexible component comprises one of a wrist band of a smart watch device or a neck band or a temple of a smart glasses device and the back plane layer is configured to one at least one of: reflect, direct or attenuate one or more body effects of the user.

3. The system of claim 1, wherein the one or more electrical components comprise one or more of a radio-frequency switch, a variable capacitor, a tunable inductor, an amplifier, a filter, or an amplifier and the one or more electrical components are arranged to provide one of a radio-frequency matching, signal filtering, impedance matching or signal conditioning of the antenna signals transmitted or received via the antenna package.

4. The system of claim 1, wherein the antenna package further comprises:
a pads layer disposed above at least a portion of the electrical conductor material of the back plane layer and beneath at least a portion of the insulating layer, wherein the pads layer comprises one or more electrical pads configured for at least one of testing of the antenna package, tuning of a frequency response of the antenna package or electrical coupling the antenna patterns with one or more electrical conductors disposed beneath the antenna package and leading to the wearable device; and
a second insulating layer disposed above at least a portion of the circuitry layer and beneath at least a portion of the antenna layer, the second insulating layer can provide electrical insulation between the one or more electrical components and the antenna pattern.

5. The system of claim 1, wherein the antenna pattern is configured to receive or transmit the antenna signals according to a wireless communication technology of a plurality of wireless communication technologies communicated using the wearable device, the wireless communication technology comprising one of: 5G new radio (NR), Long Term Evolution (LTE), narrow band Internet of Things (NB-IoT), Bluetooth, Bluetooth Low Energy (BLE), Wi-Fi, Near Field Communication (NFC), Ultra-Wideband (UWB), Global Navigation Satellite System (GNSS) communication, Zigbee, ANT wireless technology (ANT), and Long Range (LoRa).

6. The system of claim 1, further comprising a second antenna package spaced apart from the antenna package, wherein the second antenna package comprises:
a second insulating layer comprising a second dielectric material disposed above at least a second portion of the back plane layer;
a second circuitry layer disposed above at least a portion of the second insulating layer and comprising one or more components for processing second antenna signals; and
a second antenna layer comprising a second antenna pattern disposed above at least a portion of the second circuitry layer and configured for wireless communication of the second antenna signals using the wearable device.

7. The system of claim 6, wherein the second antenna package is configured to communicate antenna signals in a second one or more frequency bands of a second wireless communication technology that is different from a first one or more frequency bands of a first wireless communication technology which the antenna package is configured to communicate.

8. The system of claim 1, wherein the antenna layer is excited by a feed structure that includes at least one of: a direct feed, an aperture feed, a capacitive coupling, or an inductive coupling, wherein the feed structure is implemented via the insulating layer and the circuitry layer.

9. The system of claim 1, wherein the antenna package is configured to operate as a part of a plurality of antenna packages disposed on a front surface of the back plane layer that is opposite to a back surface of the back plane layer that faces the surface of the flexible component configured to interface with the user, wherein each antenna package of the plurality of antenna packages is electrically coupled with the wearable device via one or more electrical conductor lines at least partly disposed along the front surface of the back plane layer.

10. The system of claim 1, wherein the surface of the flexible component that is configured to interface with the user is formed using a material disposed between the back plane layer and the surface, wherein the material encloses the antenna package within the flexible component to protect the antenna package from an external element.

11. The system of claim 1, wherein the dielectric material of the insulating layer of the antenna package defines a body of the antenna package, the body formed to comprise a body portion onto which the antenna layer is disposed and to provide an air gap between the body portion and the back plane layer.

12. The system of claim 11, wherein a size of the air gap of the antenna package, that is configured for a first wireless communication technology, is different than a second size of a second air gap between a second body portion of a second antenna package and the back plane layer, wherein the second size of the second air gap is selected according to a second wireless communication technology of the second antenna package, which is different than a first wireless communication technology of the antenna package for which the size of the air gap of the antenna package is selected.

13. The system of claim 1, wherein the dielectric material of the insulating layer comprises a dielectric constant that is less than 4 and the electrical conductor material of the back plane layer comprises a metal.

14. The system of claim 1, further comprising a distance gap provided between the insulating layer and the back plane layer, wherein the distance gap is selected based on a type of wireless communication for which the antenna package is configured, and wherein the distance gap is configured to decrease at least one of detuning, attenuation, or signal loss arising from proximity to the user.

15. The system of claim 1, wherein the antenna package comprises one or more electrical contacts on a bottom side of the antenna package interfacing with the back plane layer, the one or more electrical contacts configured to electrically connect the antenna package to a corresponding one or more contacts on the back plane layer, such that the antenna package can be removed from the flexible component and replaced with another antenna package while the back plane layer remains with the flexible component.

16. A method, comprising:
providing a flexible component;
disposing an electrical conductor material of a back plane layer along a length of the flexible component, the flexible component coupled with a wearable device; and
mounting, onto the back plane layer, an antenna package, the antenna package comprising:
an insulating layer comprising a dielectric material disposed above at least a portion of the electrical conductor material of the back plane layer;
a circuitry layer disposed above at least a portion of the insulating layer and comprising one or more electrical components for processing antenna signals; and
an antenna layer comprising an antenna pattern disposed above at least a portion of the circuitry layer and configured for wireless communication of the antenna signals using the wearable device, wherein the back plane layer is disposed between antenna layer and a surface of the flexible component configured to interface with a user wearing the wearable device.

17. The method of claim 16, wherein the flexible component comprises one of a wrist band of a smart watch device or a neck band or a temple of a smart glasses device and the back plane layer is configured to one at least one of: reflect, direct or attenuate one or more body effects of the user.

18. The method of claim 16, comprising:
providing the one or more electrical components that comprise one or more of a radio-frequency switch, a variable capacitor, a tunable inductor, an amplifier, a filter, or an amplifier; and
arranging one or more electrical components to provide one of a radio-frequency matching, signal filtering, impedance matching or signal conditioning of the antenna signals transmitted or received via the antenna package.

19. The method of claim 16, comprising:
mounting, onto back plane layer, a second antenna package spaced apart from the antenna package, the second antenna package comprising:
a second insulating layer comprising a second dielectric material disposed above at least a second portion of the electrical conductor material of the back plane layer;
a second circuitry layer disposed above at least a portion of the second insulating layer and comprising one or more components for processing second antenna signals; and
a second antenna layer comprising a second antenna pattern disposed above at least a portion of the second circuitry layer and configured for wireless communication of the second antenna signals using the wearable device, wherein the second antenna package is configured to communicate antenna signals in a second one or more frequency bands of a second wireless communication technology that is different from a first one or more frequency bands of a first wireless communication technology which the antenna package is configured to communicate.

20. An antenna package in a flexible component coupled with a wearable device, comprising:
an antenna package mounted on a back plane layer of a flexible component coupled with a wearable device, the back plane layer comprising an electrical conductor material disposed along a length of the flexible component, the antenna package comprising:
an insulating layer comprising a dielectric material disposed above at least a portion of the electrical conductor material of the back plane layer;
a circuitry layer disposed above at least a portion of the insulating layer and comprising one or more electrical components for processing antenna signals; and
an antenna layer comprising an antenna pattern disposed above at least a portion of the circuitry layer and configured for wireless communication of the antenna signals using the wearable device, wherein the back plane layer is disposed between antenna layer and a surface of the flexible component configured to interface with a user wearing the wearable device.
